(19) United States
(12) Patent Application Publication
(10) Pub. No.: US 2019/0205936 A1
(43) Pub. Date: Jul. 4, 2019

(54) Symbiotic Reporting Code and Location Tracking Infrastructure for Physical Venues

(71) Applicant: OneMarket Network LLC, San Francisco, CA (US)

(72) Inventors: Raghav Lal, Palo Alto, CA (US); Ramya Raghunathan, San Francisco, CA (US); Asim Mohammad, Fremont, CA (US); Joanne McDermott, San Jose, CA (US)

(73) Assignee: OneMarket Network LLC, San Francisco, CA (US)

(21) Appl. No.: 16/124,129

(22) Filed: Sep. 6, 2018

Related U.S. Application Data
(60) Provisional application No. 62/612,568, filed on Dec. 31, 2017.

(51) Int. Cl. G06Q 30/02; H04W 4/021

(52) U.S. Cl. CPC G06Q 30/0261; H04W 84/12; H04W 4/021; G06Q 30/0267

(57) ABSTRACT

Mobile devices with multiple radios (even if software defined) create an opportunity for retail venues to present new messaging channels to visitors, even visitors who do not subscribe to or do not activate a venue app. Venue operators are uniquely situated to aggregate data before a visit and to track a user during a visit, because their sole objective is to increase overall venue traffic and conversion to sales, without favoritism among tenants.

### PRIORITY DATA

Applicant hereby claims the benefit under 35 U.S.C. 119(e) of U.S. provisional application No. 62/612,568, filed 31 Dec. 2017, entitled “SYMBIOTIC REPORTING CODE AND LOCATION TRACKING INFRASTRUCTURE FOR PHYSICAL VENUES” (Attorney Docket No. PYME 1002-1). The provisional application is hereby incorporated by reference.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Visitors to venues can download a venue specific application and get a map or narrative of what they are viewing. They can scan a code to bring up a web page, if they have the right software. But the present tools are clumsy and do not make a physical visit engaging in the same ways that online visits are engaging.

Mobile devices have been engineered to reduce their trackability and give users explicit control over sharing of data from location services. This can make it clumsier for a user to set up their mobile device to assist them during a journey. It also makes it more difficult for a venue operator to interact with a user, virtually propelling the venue operator to build their own app to run on a wide variety of mobile devices.

Recommendation engines in mobile apps are primitive, compared to their online counterparts. Data sources from which to generate recommendations are generally not available to physical location operators in the same way that they are available to search engines that touch so many aspects of an online visitor's life at and outside work.

Discerning user intent has grown very refined for search engines. For instance, hundreds of patents have issued in international class G06F covering nuances of discerning user intent. Visitors to a physical venue have not yet experienced the benefits of efforts to discern their intent and assist them in their journey. The tools of big data have yet to be practically application to the journey of visitors through physical venues such as museums, galleries, historical structures, and malls.

Beacons can be used to help determine locations of shoppers traveling through indoor shopping malls. Beacons such as iBeacons and Senion beacons use BLE to transmit identifiers that mobile devices receive and estimate their distance from the beacons. But estimating the location of the mobile device is difficult and surprisingly inaccurate, because there are many different paths for signals to take in an indoor space, as well as obstacles that absorb or reflect signals. Signal strength may vary from beacon to beacon. An opportunity arises to develop an alternative method of estimating the location of a mobile device in an indoor shopping center.

An opportunity arises to leverage mobile device tracking capabilities, big data, intent discovery and recommendation engines to improve visitors experience, both when visiting a physical venue and when exploring online venues, including virtual realities. Improved visitor experience and engagement, higher satisfaction and retention, and conversion of interests may result.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which:

FIG. 1 is a block diagram that shows various aspects of the technology disclosed.

FIG. 2 illustrates tracking of a visitor's journey through tenant locations of a physical venue in accordance with one implementation. In other implementations, the tenant locations are store locations of an independent retailer store that is not in a tenant-landlord relationship.

FIG. 3A depicts location-based infrastructure of beacons deployed to the physical venue of FIG. 1, and a server beacon resolver configured to determine visitor location based on receipt of beacon messages by a mobile device carried by the visitor.

FIG. 3B depicts location-based infrastructure of registered visitor Wi-Fi access points deployed to the physical venue of FIG. 1, and a server Wi-Fi resolver configured to determine visitor location based on receipt of MAC address and registration identifiers by the mobile device carried by the visitor.

FIG. 4 shows one implementation of an aggregated profile with a master identifier (ID) created for the visitor.

FIG. 5 lists some examples of retailer-related attributes that are included as binned profile data in the aggregated profile of FIG. 4.

FIG. 6 lists some examples of venue-related attributes that are included as binned profile data in the aggregated profile of FIG. 4.

FIG. 7 shows some examples of shopper propensities that are included in the aggregated profile of FIG. 4.

FIG. 8 illustrates a distribution server that uses the aggregated profile of FIG. 4 to send sales recommendations, gender context, dynamic pricing, and/or arrival/exit notifications to participating tenants of the physical venue in response to tenant requests. In other implementations, the participating tenants are participating independent retail stores that are not in a tenant-landlord relationship.

FIGS. 9, 10A and 10B show a conversion engine that uses the aggregated profile of FIG. 4 to identify in-retailer and overall purchase propensities for converting shoppers to in-retailer purchases.

FIG. 11 depicts one implementation of a dashboard that graphically presents various venue intelligence metrics to a venue operator.

FIG. 12 illustrates one implementation of a dashboard that graphically presents various visitor activity metrics to a venue operator.

FIG. 13 is one implementation of a dashboard that graphically depicts various shopper attributes across a plurality of shopper stratums.

FIG. 14 illustrates a message modifier that uses the aggregated profile of FIG. 4 to determine shopper intent and propensities, and in response modify messages and engagement schemes used by the tenants to interact with the shoppers. In other implementations, the tenants are independent retail stores that are not in a tenant-landlord relationship.

FIG. 15 is a message sequence chart of determining an incentive offer for a shopper using the aggregated profile of FIG. 4 and using the incentive offer to cause the shopper to return goods at a physical location instead of returning online.

FIG. 16 shows one example of the incentive offer described in FIG. 15.

FIG. 17 is a message sequence chart of determining an incentive offer for a shopper using the aggregated profile of FIG. 4 and using the incentive offer to cause the shopper to pick up goods at a physical location rather than request shipping.

FIG. 18 shows one example of the incentive offer described in FIG. 17.

FIG. 19 depicts a message sequence chart of enhancing a user browsing experience using an ensemble engine that generates product recommendations based on a shopper's purchase history, intent and propensity data identified in the aggregated profile of FIG. 4.

FIGS. 20A and 20B show one example of how the user browsing experience is enhanced by the ensemble engine of FIG. 19.

FIG. 21A shows one implementation of a training stage in which machine learning-based models are trained on training data to output user intent and propensity information.

FIG. 21B shows one implementation of a production/inference stage in which trained machine learning-based models from FIG. 21A are used to evaluate production data and output user intent and propensity information.

FIG. 22 is a message sequence chart of using the aggregated profile of FIG. 4 to make personalized recommendations to a shopper.

FIG. 23A shows one implementation of a shopper profile accessible to a retail store operator.

FIG. 23B is one implementation of an interface that can be used by a retail store operator to request new or updated shopper profiles.

FIG. 24 illustrates a first step of iteration using first, second and third beacons

FIG. 25 shows second and third steps, completing one iteration using three beacons.

FIG. 26 illustrates a method to set a reporting threshold for interested store operators at a mall.

FIG. 27 illustrates a chart of percentages of beacon circumferences captured within uncertainty distance range buckets, for 930 scans.

FIG. 28 shows a histogram and a chart evaluating alternative path loss exponents, based on numerous readings in a handful of malls, leading to selection of 4.5 as an exponent for a mall during store operating hours.

FIG. 29 shows a chart with results from six useful options for the convergence algorithm.

FIG. 30 is one implementation of a computer system that can be used to implement the technology disclosed.

### DETAILED DESCRIPTION

### Introduction

Retail venues, now called “brick and mortar”, face stiff competition from online portals, which are perceived as having lower prices, better selection, and delivery. Portals have the further advantage of ease of use, when well designed, and powered by recommendation engines.

Mobile devices with multiple radios (even if software defined) create an opportunity for retail venues to present new messaging channels to visitors, even visitors who do not subscribe to or do not activate a venue app. Venue operators are uniquely situated to aggregate data before a visit and to track a user during a visit, because their sole objective is to increase overall venue traffic and conversion to sales, without favoritism among tenants.

Structural safeguards and contractual commitments allow a venue operator to aggregate individualized visitor data across tenants of numerous venues and combine tenant data with other retailer data for analysis. Anonymized aggregate data, in the sense that contributions to individual visitor aggregates cannot be reverse engineered, can be stored side-by-side with retailer-specific data, without risk of leakage between retailers. This involves careful architecting of database structures and access routines.

On the data collection side, physical control of venue common space allows the venue operator to combine membership-based free WiFi with symbiotic software loops in active background applications, which report encrypted BLE beacon messages for decryption, to accurately track a visitor's journey through an indoor venue, while respecting user permissions. Cooperation with tenants allows the venue operator to extend hyper-location tracking beyond entry into a tenant's space, beyond the common areas. This involves substantial physical infrastructures. With this overview in mind, additional detail is more easily understood.

Access to point of sale and online sale data, at a SKU/UPC level and across retailers who view themselves as competitors, allows a venue operator to predict aggregate purchasing propensities, as well as retailer specific purchasing patterns. For instance, artificial intelligence systems can be trained with data that ordinarily could not be aggregated. Separate models can be trained with the aggregated and retailer-specific data. Training models on binned data is more efficient and practical than training on of individual purchase events. Binning requires creation and maintenance of a SKU hierarchy that spans diverse product offerings of tenants and other retailers, because there are too many SKUs to train artificial intelligence systems using individual SKUs. Practically, the venue operator's SKU hierarchy should also be a Rosetta stone of sorts, providing two-way translation between the AI's hierarchy of categories and each retailer's own hierarchy of categories. The SKU hierarchy is structured to power an individualized recommendation engine (as opposed to look alike, collaborative filtering.) New applications of big data analytics to prediction of purchase propensities are possible with newly aggregated data, with binning facilitated by a cross-retailer SKU hierarchy. Pre-calculation from historical, binned data can be combined with location tracking indoors, within a venue, during a visitor's journey or “at a moment in time.”

Symbiotic software loops in a critical mass of active background applications can effectively report and decode encrypted beacons and other signal propagated indoors, within a venue that a visitor's mobile device otherwise would miss if the visitor did not activate the venue's app or subscribe to the venue's free Wi-Fi. Symbiotic software loops are developed using software developer kits (SDKs) adopted by popular applications that are interested in geo location of users. Symbiotic software code is called from the main processing loop of an application when the application is in the foreground or the active background. The active background operation is important, because applications are quickly displaced from the foreground into the background. Mobile device operating systems limit the number of background applications that are active, in order to conserve battery life. If a mobile phone, for instance, has 15 applications loaded in the background, a handful, perhaps four or five of those applications are in the active background. Applications in the active background continue to operate, without painting the display. Presence in the active background makes an application effective at listening for encrypted BLE beacon signals. When two, three or half a dozen social media, ride sharing, navigation and other location-aware applications on an individual mobile device implement symbiotic software loops, it is likely that one of the applications will be in the foreground or active background throughout a visitor's journey at the venue. By accepting active background processing, the portals that sponsors an application gains improved location resolution while the mobile device is indoors; symbiotically, the venue operator gains a new tool for tracking a visitor's journey. For instance, a ride sharing operator can tell which door at which level a visitor is approaching as they exit an airline terminal to catch a ride, even before the sky is visible to the mobile device's GPS. This encourages the application portal to adopt the symbiotic software loop, as one of multiple tracking approaches.

Membership based free Wi-Fi is another tool for location tracking, using access point infrastructure that reports data about connected mobile devices. Before a mobile device connects, its MAC address is likely to be obfuscated. Mobile devices have been engineered to obfuscate MAC addresses, prior to actual network connection, in order to defeat unauthorized location tracking. For instance, one manufacturer of popular cell phones rotates the obfuscated MAC address approximately every six hours. Its mobile devices use an obfuscated MAC address prior to actual connection to an access point. Membership based free Wi-Fi access provides an identifier, such as email address, that the links a connected MAC address to aggregated data for the mobile device. Upon connection, the MAC address becomes a unique identifier for following a visitor's journey, reported by access point infrastructure as the visitor moves through the venue. Without a connection, infrastructure can merely track the obfuscated MAC address, without being given a meaningful identifier of the mobile device.

Tracking and unveiling obfuscated MAC addresses is an opportunity afforded by venue infrastructure with multiple radio infrastructures. Prior to a Wi-Fi connection, symbiotic software loops can follow mobile device through the venue. Upon connection, a server can correlate location data from symbiotic software loops with tracking location data from the obfuscated MAC address. In some instances, the simple correlation between beacon location resolution and obfuscated MAC address location resolution can be provide a reliable correlation. In other instances, connection of the Wi-Fi in to an access point will strengthen the correlation enough to match obfuscated journey location information with beacon derived location data. Operation and coordination of the two infrastructures creates an opportunity for linking tracks independently generated from the mobile device.

Estimating the location of a mobile device within an indoor area is difficult because location signals are noisy. Signals are noisy for multiple reasons. A mobile device may register different received signal strength indicators for a specific beacon during a given scan period. This variance occurs, for example, when the mobile device is moving or there are objects that intermittently impair signals being transmitted. In addition, environmental objects may absorb, reflect, or otherwise interfere with signals. For example, a closing door may impede a transmitted wireless signal. Environmental factors may cause signal attenuation to vary significantly in a short time period.

A relationship between the strength of a signal from a beacon and the distance of the device to the beacon is determined in order to estimate a path loss exponent (PLE). The PLE is an expression of signal attenuation. To ensure that the estimated PLE value is appropriate for an indoor mall during store operating hours, the estimated PLE value is evaluated against alternative PLE values. Using the relationship derived from a regression for an appropriate estimated PLE value, a Haversine distance from a beacon can be interpolated using the beacon's known RSSI value and transmitter power. The interpolated beacon distances allow the algorithm to iteratively multilaterate the mobile device using three or more beacons.

Using the determined relationship for the appropriate PLE value, estimated locations of the device are iteratively calculated using a convergence algorithm. The convergence algorithm selects three or more beacons and a starting point. Using gradient descent, the starting point is iteratively moved towards a point that is simultaneously closest to each of the beacons based on the estimated distances. This point is the best estimate of the location of the mobile device. The iteration process stops when the convergence algorithm reaches a convergence condition.

Location data can be combined with periodically calculated propensity data to enhance a visit to a venue. The visitor's likely intent for a visit can be predicted upon arrival by accessing data that has been analyzed for patterns and propensities. When a visitor arrives at a venue, they can be identified and propensities retrieved, which have been pre-calculated on a periodical basis applying big data techniques to aggregated, binned, category-level SKU data. Profile and propensity data, including destination specific and aggregated propensity data can be fed to retailers at the venue.

The venue operator can solicit greeting messages for an identified visitor upon arrival. Greeting messages can featured products and include incentives, or provide friendly greetings. The venue operator can improve the user experience by prioritizing and/or grouping messages. The number and content of messages delivered can be determined by the venue operator to improve visitor experience, to avoid bombardment of the visitor with excessive, noisy messaging. This greeting protocol sometimes is enhanced by a strong indication of the visitor's intent.

Aggregation of data will sometimes allow a strong prediction of a visitor's primary and secondary intent immediately upon arrival, based either on recent behaviors or periodic patterns. For instance, a visitor who browsed online for repair services in the last hour may be headed to a repair shop at the venue; they may have an expected waiting time for completion of the repair. Recent browsing activity may suggest where to direct the user during their waiting time and what kind of messaging will enhance the visitor's journey. Periodic behavior, such as picking up coffee midmorning or eating lunch at the venue, also can be ascertain from the profile and the aggregated data, which can be combined when soliciting candidate messages.

Profiles created using aggregated and retailer-specific data also can be used to precipitate a visit, thereby increasing foot traffic in the venue. Two opportunities to bring an online user to a store are order fulfillment order and return of goods purchased online.

When a user buys from a retailer who has a physical presence at a location that the user visits, the online user may be converted to a visitor by offering to make the goods available immediately at a pick-up counter at a venue. This may require little effort for frequent visitors, as indicated by their retailer-specific profiles. Pick-up today caters to some of the same instincts that cause coffee buyers to pre-order and prepay their morning java dose, for pickup without waiting in line. A user who seldom visits the retailer's physical location may require an extra nudge.

Customized incentives to pick up goods by visiting a physical location can be crafted based on goods specific information and a user profile. While free shipping is enticing to buyers, it is not free to sellers. Part of a custom incentive can be funded by reduced shipping costs. Many shoppers buy a few more things when they happen to visit a venue, so an incentive can be fashioned for discounted purchases today, for instance, that increase the likelihood that a visit to pick up goods will convoy additional purchases.

Elasticity, as a factor in customization of pickup incentives, can be assessed using data aggregated across retailers, which will reveal users with a propensity to take advantage of pick-up today options. It also may reveal proven pick-up visitors who are not aware of a pick-up location that would be convenient for them to visit.

Return of goods purchased online is a further opportunity to precipitate a visit that increases foot traffic in the venue. Returns can be more expensive for an online retailer to process than fulfillments, when the return address is different than the fulfillment address. This is the case when fulfillment is directly from a manufacturer's warehouse, instead of a retailer's distribution center. A customized incentive can be offered to return or exchange goods in-store, potentially avoiding two-way shipping costs. As with pick up of goods, part of a custom incentive can be funded by reduced shipping costs. Another part of an incentive can be based on a likelihood that a visit to pick up goods will convoy additional purchases. Elasticity can be assessed to gauge an amount of incentive that is likely to succeed in precipitating a visit.

During a visit, whether detected or precipitated, ensembles can be offered on an individualized basis. In general, recommendation engines typically are based on look-alikes, what other customers bought along with the current SKU/product. Current recommendation engines do not check size availability or take into account a particular online visitor's brand, color or style preferences. With a SKU category hierarchy, individualized visitor histories and binned profiles can be used to fashion product ensembles that are individualized. From look-alike data, ensembles of SKU/product categories can be assembled. Individual SKUs/products can be selected to fill the categories from individualized data. Product availability can be taken into account when an individualized ensemble is constructed. This approach can be applied both in store and online. In a store, a user who is browsing the retailer's app or the venue operator's app can receive from a server personalized ensemble recommendations. Or a personal shopping assistant or concierge can receive the recommendations and convey them to the shopper. Online, the user can receive the personalized recommendations as browsing and buying proceed.

Aggregated data can be utilized increase sales in underrepresented categories, both during physical and online visits and by direct marketing. Retailers tend to underestimate buying propensity for a sizable portion of their customers, when they make estimates based on retailer-specific purchases. In one sample, 18 percent of users had a higher overall purchase propensity for makeup than would be estimated from their retailer-specific history. At the point of sale, during a visit, a sales person can be given an overall propensity for SKUs/products in a department, for an ensemble, or across the store. Categories in which the overall propensity exceeds the retailer-specific propensity can be highlighted to a sales person to motivate efforts to convert the visitor to fulfill their intent in-store, instead of elsewhere. Incentives can be provided to help convert the visitor. Online, featured products can be selected based on the overall propensity and can be directed to conversion of intent to goods available from the online retailer's own site. Direct marketing also can take advantage of identified opportunities with messages and incentives designed to capture a larger share of a current customer's spend in a category that is more often fulfilled elsewhere.

During online visits, gender context intent can be determined from aggregate history data, including both online and physical history, based on Bayesian likelihood of within SKU/product categories, brand or retailer or based on recent browsing. Many households have a Chief Shopping Officer. In households of four people, some CSOs will shop for male and female adults and male and female dependents, plus friends and relatives. When they visit online looking for pants, are they looking on behalf of a male or female and on behalf of an adult or child? Binned profile data within a SKU/product category hierarchy can yield a Bayesian likelihood of gender context and/or age context. The Bayesian estimate is stronger when more factors are taken into account. Often, different retailers are visited to satisfy different gender contexts and or age contexts. Brands also can differentiate between gender and age contexts. Once gender and approximate age contexts are established, specific propensities and preferences, as discussed above regarding ensembles, can be brought to bear so the first array of products displayed have a substantial likelihood of matching the visitor's intent.

Considering again physical visits, extra attention can be directed to visitors who have a history of buying luxury goods. Retailers that have active customer service tend to sell at least some high priced or luxury goods. Selling high priced goods with a substantial margin pays for customer service and even for personal shopping service. Customer profiles can be used to identify luxury shoppers and big spenders when they start their journey through a venue. Journey tracking technologies described above can follow the visitor as they approach a particular retailer. Customer service, personal shopping or concierge staff can be alerted to the arrival of high value visitor. A picture can be provided from a profile, if available. A real time approach track, as available with ride sharing services, also could be provided from the BLE and/or Wi-Fi tracking infrastructures described above.

Overall, a combination of precise location tracking, without requiring visitor activation during a journey, and big data analysis of data aggregated across retailers/venues/platforms has many opportunities for brick and mortar retailers to recapture market share from online platforms by providing new services that have no online analog and by reproducing and adapting the best of online experiences for location-based experiences.

During a visit, whether detected or precipitated, ensembles can be offered on an individualized basis. In general, recommendation engines typically are based on look-alikes, what other customers bought along with the current SKU/product. Current recommendation engines do not check size availability or take into account a particular online visitor's brand, color or style preferences. With a SKU category hierarchy, individualized visitor histories and binned profiles can be used to fashion product ensembles that are individualized. From look-alike data, ensembles of SKU/product categories can be assembled. Individual SKUs/products can be selected to fill the categories from individualized data. Product availability can be taken into account when an individualized ensemble is constructed. This approach can be applied both in store and online. In a store, a user who is browsing the retailer's app or the venue operator's app can receive from a server personalized ensemble recommendations. Or a personal shopping assistant or concierge can receive the recommendations and convey them to the shopper. Online, the user can receive the personalized recommendations as browsing and buying proceed.

During online visits, gender context intent can be determined from aggregate history data, including both online and physical history, based on Bayesian likelihood of within SKU/product categories, brand or retailer or based on recent browsing. Many households have a Chief Shopping Officer. In households of four people, some CSOs will shop for male and female adults and male and female dependents, plus friends and relatives. When they visit online looking for pants, are they looking on behalf of a male or female and on behalf of an adult or child? Binned profile data within a SKU/product category hierarchy can yield a Bayesian likelihood of gender context and/or age context. The Bayesian estimate is stronger when more factors are taken into account. Often, different retailers are visited to satisfy different gender contexts and or age contexts. Brands also can differentiate between gender and age contexts. Once gender and approximate age contexts are established, specific propensities and preferences, as discussed above regarding ensembles, can be brought to bear so the first array of products displayed have a substantial likelihood of matching the visitor's intent.

Aggregated data can be utilized increase sales in underrepresented categories, both during physical and online visits and by direct marketing. Retailers tend to underestimate buying propensity for a sizable portion of their customers, when they make estimates based on retailer-specific purchases. In one sample, 18 percent of users had a higher overall purchase propensity for makeup than would be estimated from their retailer-specific history. At the point of sale, during a visit, a sales person can be given an overall propensity for SKUs/products in a department, for an ensemble, or across the store. Categories in which the overall propensity exceeds the retailer-specific propensity can be highlighted to a sales person to motivate efforts to convert the visitor to fulfill their intent in-store, instead of elsewhere. Incentives can be provided to help convert the visitor. Online, featured products can be selected based on the overall propensity and can be directed to conversion of intent to goods available from the online retailer's own site. Direct marketing also can take advantage of identified opportunities with messages and incentives designed to capture a larger share of a current customer's spend in a category that is more often fulfilled elsewhere.

Considering again physical visits, extra attention can be directed to visitors who have a history of buying luxury goods. Retailers that have active customer service tend to sell at least some high priced or luxury goods. Selling high priced goods with a substantial margin pays for customer service and even for personal shopping service. Customer profiles can be used to identify luxury shoppers and big spenders when they start their journey through a venue. Journey tracking technologies described above can follow the visitor as they approach a particular retailer. Customer service, personal shopping or concierge staff can be alerted to the arrival of high value visitor. A picture can be provided from a profile, if available. A real time approach track, as available with ride sharing services, also could be provided from the BLE and/or Wi-Fi tracking infrastructures described above.

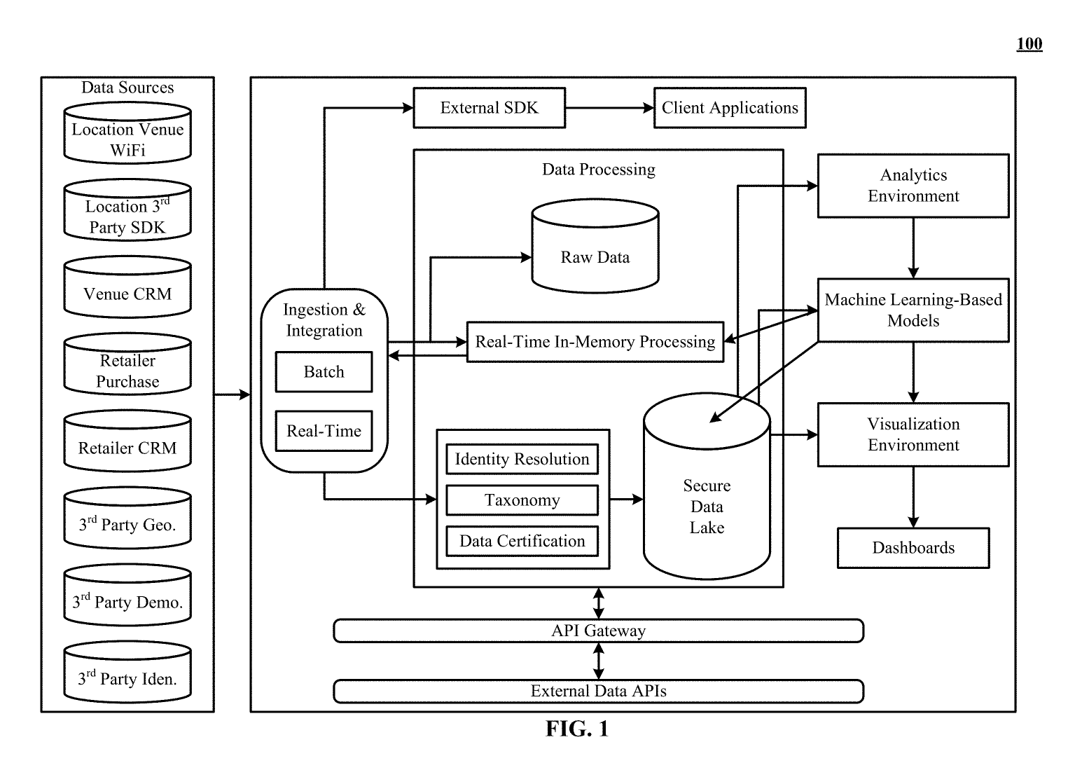

FIG. 1 is a block diagram that shows various aspects of the technology disclosed. FIG. 1 includes system 100. System 100 includes a plurality of data sources, such as WiFi-based location data from venue WiFi access points, beacon-based location data from 3^{rd} party SDKs, venue customer relationship management (CRM) data, retailer purchase data, retailer CRM data, 3^{rd} party geolocation data, 3^{rd} party demographics data and 3^{rd} party identity data.

System 100 also includes an ingestion and integration sub-system, which can provide batch processing (e.g., Hadoop or Storm) as well as stream or real-time processing (e.g., Spark). Both processing styles can use a messaging queue such as Kafka as a source and/or sink.

Data from the data sources and via the ingestion and integration engine is provided to a data processing sub-system. Data processing sub-system includes a real-time in-memory processing component which can use machine learning-based models to predict insights in real time. Examples of predictive insights include user intent and user propensities. Examples of machine learning-based models include logistic regression-based models, convolutional neural network-based models, recurrent neural network-based models (e.g., models that use long short-term memory networks or gated recurrent units), fully-connected network-based models, and multilayer perceptron-based models.

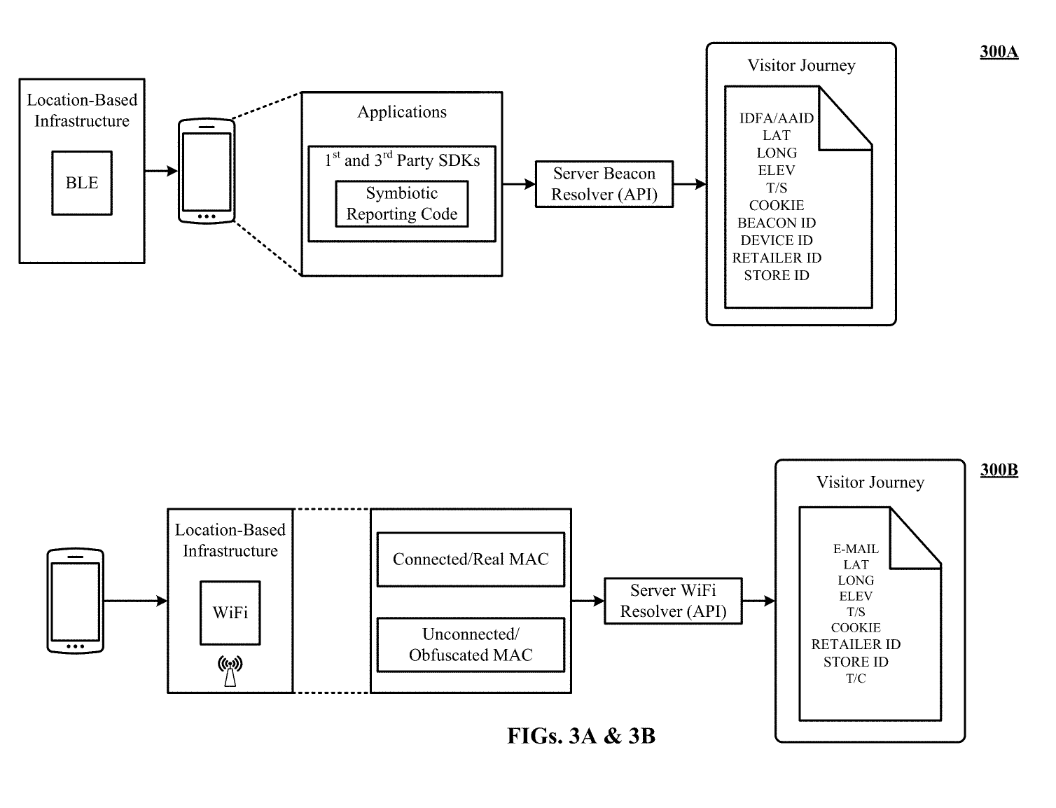

Data processing sub-system also includes an identity resolution component which performs entity disambiguation to populate and update aggregated profiles of user (or shoppers), as described later in this application with reference to FIGS. 3A and 3B. Data processing sub-system also includes a taxonomy component which normalizes product names across multiple retailers using unique product SKUs and creates a bi-directional taxonomy. The bi-directional taxonomy can be used by an analytics environment to determine product specific metrics across the multiple retailers and present such metrics on the frontend using product names that are specific to each of the retailers.

Data processing sub-system also includes a data certification component that enforces compliance of data processing and storage operations with data privacy and authentication regulations such as General Data Protection Regulation (GDPR). Certified data can be stored in a secure data lake. Secure data lake can also store outputs and predictions from the trained machine learning-based models. A visualization environment can access the secure data lake to present various retail and shopper metrics to store operators via dashboards.

Data processing sub-system can interact with the end users (or shoppers) using the external SDK running on client applications active on mobile devices of the end users. One example of such user interaction includes sending a coupon or product recommendation to a shopper. Unprocessed data from the data sources can be stored in the raw data database of the data processing sub-system. Data processing sub-system can use various APIs to communicate with external application servers belong to participating tenants or stores.

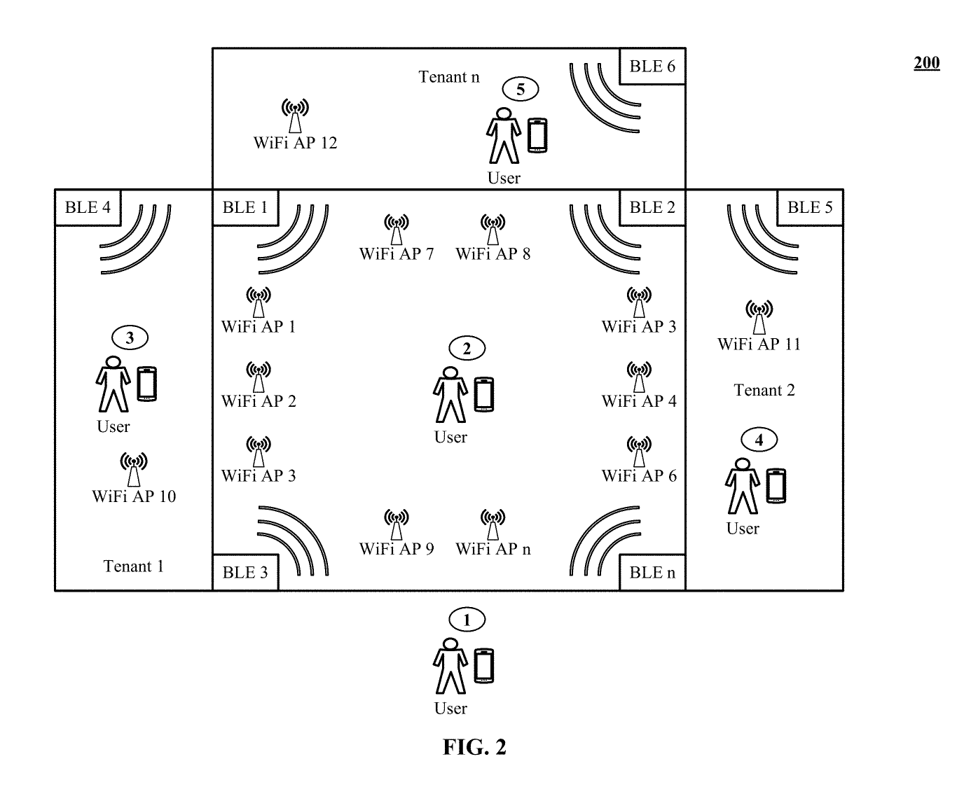

FIG. 2 illustrates tracking of a visitor's journey through tenant locations of a physical venue in accordance with one implementation. In other implementations, the tenant locations are store locations of an independent retailer store that is not in a tenant-landlord relationship. In the illustrated embodiment, physical venue 200 includes three tenants, tenant 1, tenant 2 and tenant three and the visitor's journey is tracked across the three tenants using location-based infrastructure deployed at the physical venue. Examples of location-based infrastructure include Bluetooth Low Energy-based beacons and WiFi access points.

At time 1, the visitor is tracked outside the physical venue 200, for example at a parking lot. At time 2, the visitor's arrival at the physical venue 200 is detected, as well as her departure from the parking lot. At time 3, the visitor's arrival at tenant 1's location is detected, as well as her departure from the tenant 1's location. At time 4, the visitor's arrival at tenant 2's location is detected as well as her departure from the tenant 12's location. At time 5, the visitor's arrival at tenant n's location is detected, as well as her departure from the tenant 2's location.

FIG. 3A depicts location-based infrastructure of beacons deployed to the physical venue of FIG. 1, and a server beacon resolver configured to determine visitor location based on receipt of beacon messages by a mobile device carried by the visitor. In FIG. 3A, symbiotic reporting code, running in active background applications (as part of 1^{st} or 3^{rd} party SDKs), reports and decodes encrypted beacons that the visitor's mobile device otherwise would miss if the visitor did not activate the venue's application or subscribe to the venue's free Wi-Fi. The beacon messages reported by the symbiotic reporting code are received by the server beacon resolver, which serves as an API. The beacon messages 300 include a payload which encodes the visitor journey using data such as IDFA (for iOS devices), AAID (for Android devices), location data such latitude, longitude, elevation, timestep, cookie, beacon ID, device ID, retailer ID, and store ID.

FIG. 3B depicts location-based infrastructure of registered visitor Wi-Fi access points deployed to the physical venue of FIG. 1, and a server Wi-Fi resolver configured to determine visitor location based on receipt of MAC address and registration identifiers by the mobile device carried by the visitor. WiFi access points use real or obfuscated MAC addresses to send data payloads to the server WiFi resolver. These payloads also encode the visitor journey using data such as e-mail, location data such latitude, longitude, elevation, timestep, cookie, device ID, retailer ID, store ID, and terms and conditions.

### Location Tracking Using Multilateration From BLE Beacon Signals

The convergence algorithm disclosed combines distance estimates based on measured RSSI of three or more beacons with iterative convergence on a final estimated location of the mobile device. The stronger the signal, the closer the device is to a beacon. A similar approach can be applied to WiFi access points having known or announced transmission power. A beacon's RSSI value is inversely proportional with the negative logarithm of its distance from the mobile device. Accuracy of a location estimate is evaluated after convergence to determine the extent to which the estimate is actionable. A calculated path loss exponent of 4.5 was used to relate measured RSSI to distance for certain beacons in urban malls, using data collected from hundreds of points in several malls. Alternative path loss coefficients can be calculated for other signal sources, such as access points, and for other environments, such as downtown shopping districts or strip malls. A PLE of 4 to 4.7 or of 3.5 to 4.8 also could be used, with lower PLEs applicable to more open environments such as shopping districts. Different signal sources, uniquely identified or categorically identified, can have different path loss exponents. Signal sources with variable power can have different path loss exponents at different times.

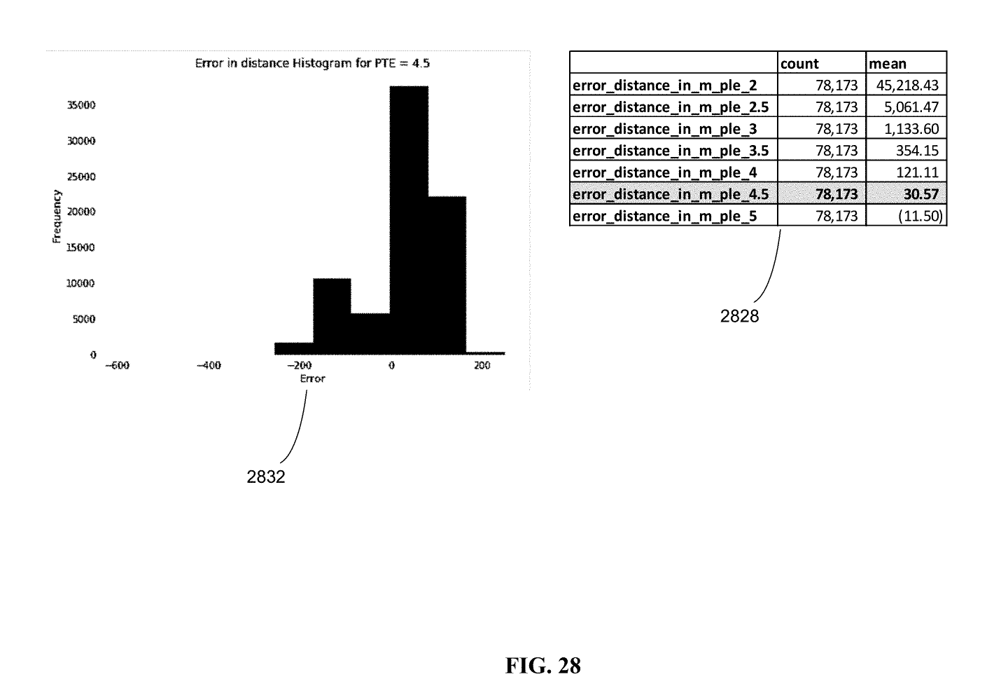

FIG. 28 shows a histogram 2832 and a chart 2828 evaluating alternative path loss exponents, based on numerous readings in malls during store operating hours, leading to selection of 4.5 as an exponent for certain circumstances. We provide the following example of how to set a path loss exponent, PLE. Being a measure of signal attenuation, the PLE varies depending on the environment as well as the objects placed in the environment. A PLE value of 2 is has been reported for free space, while larger PLE values are found in environments with more attenuation. Potential PLE values were evaluated for use in the equation:

RSSI=−10 n ln(d)+A

The development team substituted alternative PLE values into this equation to calculate beacon distances. They then calculated RMS differences from error variances between these calculated distances and distances calculated by a location SDK running on the mobile device. The location measurement made by the location SDK for indoor locations was more noisy and less accurate than the estimated device location calculated by the convergence algorithm, but could be useful for evaluating PLE values.

The chart 2828 shows what we call an average uncertainty distance RMS measure, labeled RMS difference values (in meters), for PLE values ranging from two to five. Calculation of an uncertainty distance RMS measure (not to be confused with an uncertainty distance) relates an estimated location to circumferences drawn around each of the beacons, as described below. Although the mean RMS difference for the PLE value of 4.5 was larger than that for a PLE of 5, the PLE of 4.5 was chosen for the mall because a PLE of 5 would overestimate the amount of signal attenuation. The convergence algorithm disclosed converges better with an underestimate of signal attenuation than with an over estimate, with an overestimate of distance from a beacon than an underestimate of distance. The histogram 2832 shows a distribution of different RMS values for a PLE of 4.5.

The mobile device can filter a set of beacons to the same floor (or plane) as the mobile device, for instance, in a multi-level mall. It can use the RSSI values of in a filtered set. In some implementations, all beacons visible on the same floor are used. Beacons with zero or saturated signal strength can be filtered out. In some implementations, filtering also can reduce the set to a maximum number of beacons or just a portion of the beacons with the strongest signal. For instance, a maximum of 5, 10 or 15 beacons can be used or a range of 5 to 10 or 5 to 15 beacons. Alternatively, an RSSI threshold could be set and applied if more than 5 or 10 or 5 to 10 beacons satisfy the threshold. Or, a proportion of strongest beacons can be used, such as half or two thirds of the beacons visible or of the beacons that satisfy the RSSI threshold. Multilateration begins with a set of beacons that have measured RSSIs.

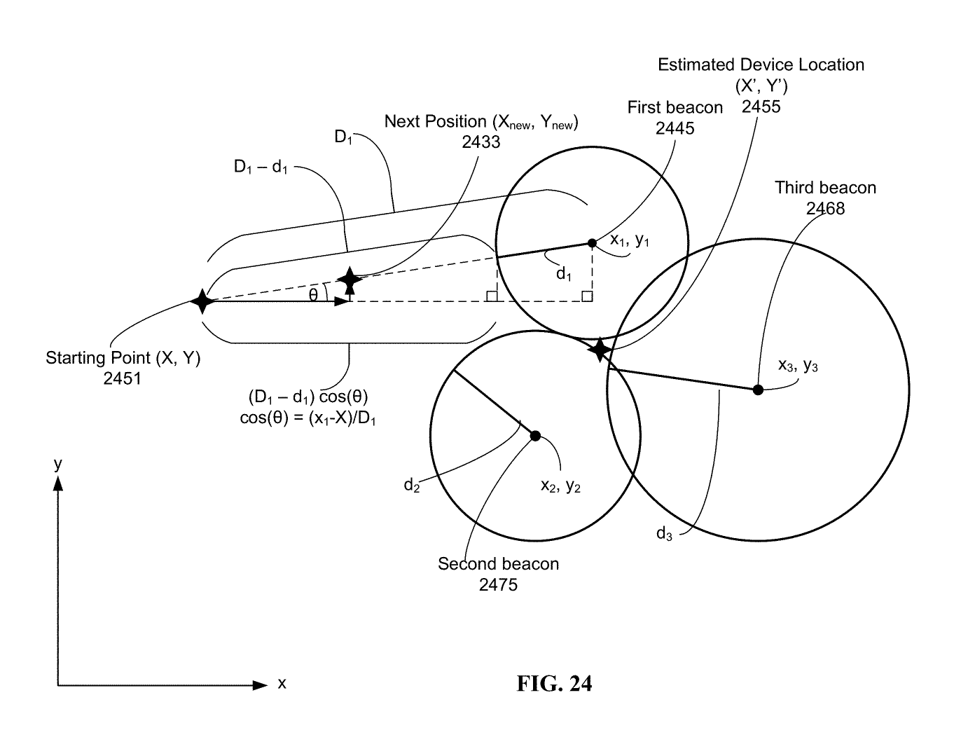

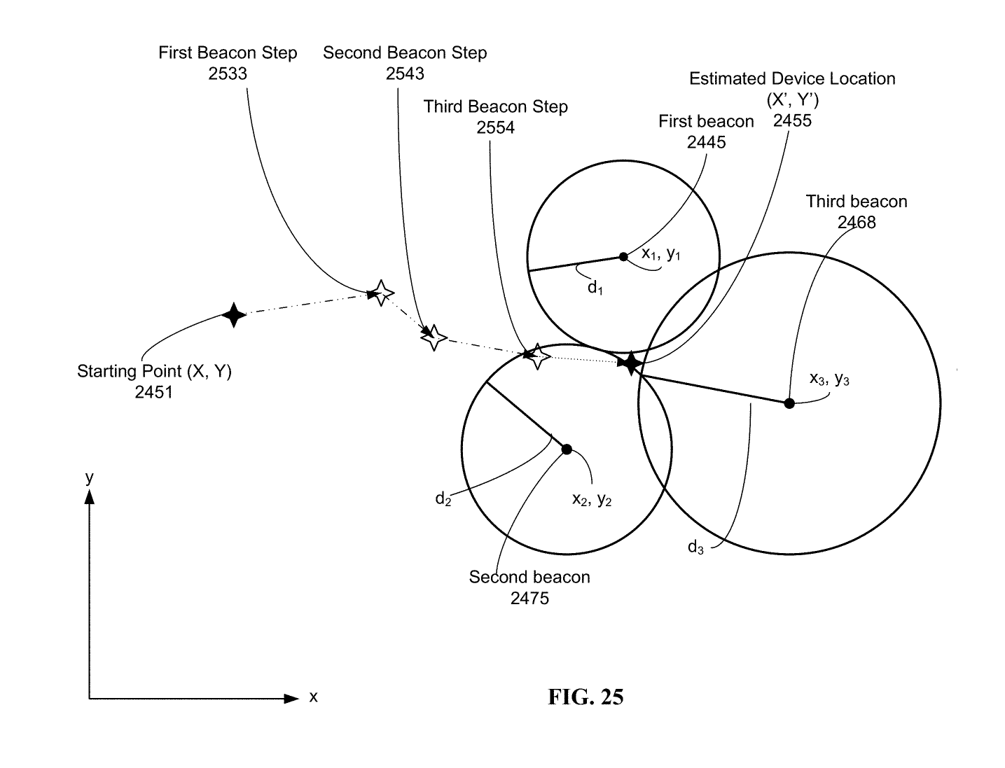

When performing convergence, a starting point is chosen, for instance outside all of the measured distances from the beacons or at a centroid of beacons being used in the particular calculation. The convergence algorithm successively moves the current estimate toward individual beacons. One convergence iteration include steps that move the current estimate toward each beacon, in turn, that is being used for multilateration. FIG. 24 shows a first step, towards a first beacon. FIG. 25 shows second and third steps, completing one iteration using three beacons.

FIG. 24 illustrates a first step of iteration using first, second and third beacons 2445, 2475 and 2468. The beacons have the coordinates (x₁, y₁), (x₂, y₂), and (x₃, y₃). A starting point 2451 is located at (X, Y), and a final estimated position 2455, after convergence is located at (X′, Y′). The starting point 2451 may be arbitrarily chosen. In one implementation, the starting point 2451 is the centroid of all the beacons used during the scan within the scan area. In the figure, the starting point is to the left of circumferences, with radii d₁, d₂, and d₃, drawn around the beacons. In other implementations, the starting point 2451 is chosen to be the point (0, 0) on a coordinate system. Preferably, the starting point is outside the circumferences drawn around the beacons, but convergence can be achieved even when the starting point is within a circumference, recognizing that the starting point is inside circumference(s) and adjusting a parameterized step rate accordingly. The parameterized step rate controls the magnitude of a movement towards a beacon.

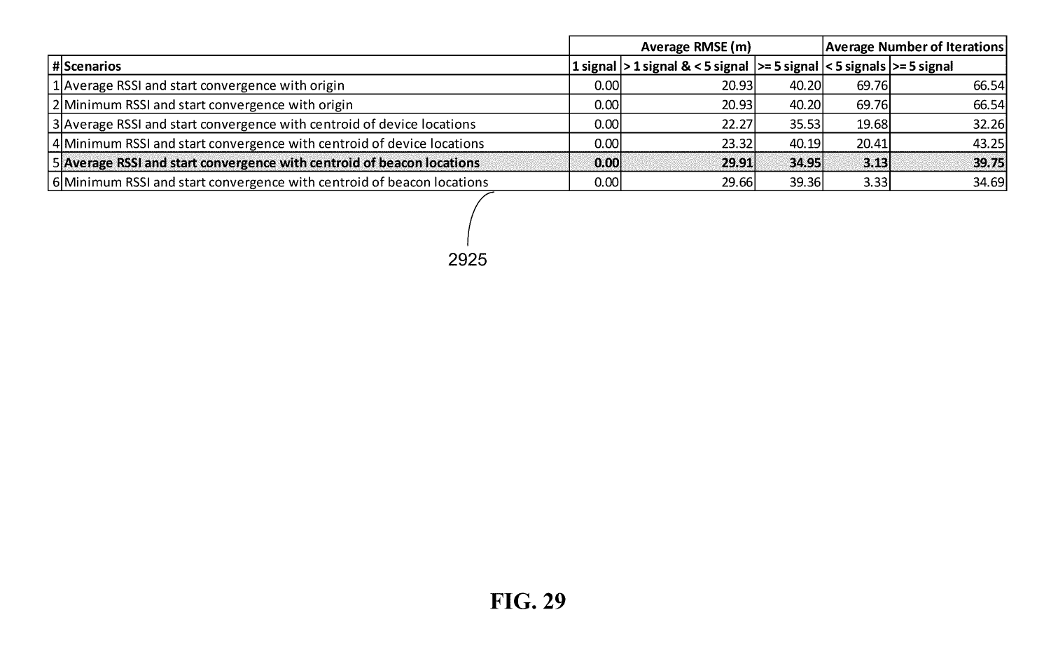

The distances d₁, d₂, and d₃ are derived from measured RSSI values using the PLE in the formula above. In FIG. 24, distances derived from RSSI values are depicted as circles with radii d₁, d₂, and d₃ drawn around the respective beacons. The device sometimes measures multiple RSSI values for one beacon during a scan period. A scan period of six seconds was used in development. A shorter or longer scan period can be used, depending on the frequency of beacon broadcasts and the efficiency of the mobile device in processing scans. For instance, a scan period can be 2, 4, 6, 8 or 10 seconds or in any range between two of these values. When multiple measurements are received from a beacon during a scan, the mobile device can use the beacon's average RSSI value, its minimum value, or its maximum value as input to the iterative convergence. FIG. 29 shows a chart 2925 with results from six useful hyperparameter options for the convergence algorithm, combining two rules for handling multiple RSSI readings from the same beacon with three alternative starting estimate positions from which to converge on a final estimated location.

FIG. 24 further illustrates movement by a selected distance towards a beacon in each step, beginning from a starting point 2451. In this implementation illustration, the selected distance is half the distance between the current estimate and a closest point on the circumference of a circle around beacon n with a radius of dₙ. For example, the starting point 2451 first moves toward the first beacon 2445. The distance moved is half the distance between a current estimated location and the circumference of the circle, which we sometimes call the uncertainty distance (not to be confused with an uncertainty distance RMS measure). The vector of movement can be along a segment connecting the current estimate with the center of the circle. The distance moved can be expressed as ½(D₁−d₁), where D₁ is the distance between the starting point 2451 and the first beacon, (D₁−d₁) is the uncertainty distance, and ½ is the parameterized step rate. In one implementation, x and y components are processed separately. The x and y parts of the distance can be calculated using cosine and sine functions of the angle θ with the x-axis. Or, a difference in coordinate positions can be calculated by subtraction. Substituting the expressions sin

$$θ = ( \frac{{y}_{1} - Y}{{D}_{1}} ) and cos θ = ( \frac{{x}_{1} - X}{{D}_{1}} )$$

yields the equations that step the device's estimated position from the initial position 2451 to the next position 2433. One formula that can be applied without sine and cosine functions is:

$$\begin{matrix}{X}_{new} = X + \frac{1}{2} ( \frac{{x}_{1} - X}{{D}_{1}} ) ( {D}_{1} - {d}_{1} ) & ( 1 ) \\ {Y}_{new} = Y + \frac{1}{2} ( \frac{{y}_{1} - Y}{{D}_{1}} ) ( {D}_{1} - {d}_{1} ) & ( 2 )\end{matrix}$$

Successive steps of convergence repeats these calculations for additional beacons.

In other implementations, the parameterized step rate may be less than or greater than ½. Choosing a fraction less than ½ may result in a more accurate position estimate, but will increase the number of iterations of the algorithm. Conversely, choosing a fraction greater than ½ will decrease the number of iterations of the algorithm, but may result in a less accurate position estimate.

FIG. 25 continues the iteration that began in FIG. 24. In the second step 2543, the current estimate steps halfway toward the circumference around the second beacon 2475, which has a radius d₂. In the third step 2554, the current estimate steps halfway toward the circumference around the third beacon 2468. The algorithm iterates until the estimated device location 2455 reached when a convergence condition is satisfied. Iteration can be terminated after a maximum number of iterations without reaching convergence. A limit such as 100 or 1,000 or 5,000 iterations can be set, or in a range of 100 to 1,000 or 100 to 5,000. The range selected can relate to resource consumption, including battery drain and control loop time.

The convergence algorithm concludes iteration when it meets a convergence condition. For instance, a convergence condition can be satisfied when an RMS margin is less than a meter or one-tenth of a meter. Calculation of an uncertainty distance RMS measure is explained below. The RMS margin is the difference between uncertainty distance RMS measures in successive iterations. Another convergence condition that can be used is when the RMS average distance to beacon circumferences calculated by the convergence algorithm falls below a threshold. One example of a threshold may be 30 meters. Other example thresholds are 20 meters and 10 meters or in a range of 10 to 30 meters or 20 to 30 meters.

One convergence condition is the distance moved over the course of an iteration cycle is less than a predetermined threshold. A movement threshold of 0.1 m (10 cm) has been used as the convergence condition. A threshold in a range of 0.01 m (1 cm) through 1 m (100 cm) could be used. A variety of thresholds could be chosen, as modest resources needed to perform one or a hundred iterations.

Another convergence condition that could be used is an uncertainty distance RMS measure, mentioned above. A convergence condition could be satisfied when the uncertainty distance RMS measure is less than a threshold, such as 30 m or 5 m. This condition, which produces a good enough result, could be combined with a movement threshold condition that produces a result not likely to improve much. Or, a convergence condition could be satisfied when a change in uncertainty distance RMS measure between iterations is less than a threshold.

When the algorithm has reached a convergence condition, the convergence algorithm returns the x and y coordinates obtained during its final iteration. These coordinates represent the estimated device location 2455 for the mobile device's position.

Returning to the mechanics of calculations, the uncertainty distance RMS measure is an RMS-like value. It is an RMS average of distances from an estimated position to circumferences drawn around beacons used in the multilateration. The following measure was used in selection of a PLE and can be used to determine the degree to which a final multilateration result is actionable:

$$\sqrt{\frac{1}{k} {\sum }_{i = 1}^{k} {( Distance [ ( {x}_{i} , {y}_{i} ) , ( {X}_{new} , {Y}_{new} ) ] - {d}_{i} )}^{2}} \qquad ( 3 )$$

In formula (3), k represents the number of beacons used in multilateration. In FIGS. 24-25, k=3. The function (Distance [(xᵢ, yᵢ), (X_{new}, Y_{new})]) , also symbolized as Dᵢ, represents the distance from an estimate location to a beacon i at the center of a circumference of radius dᵢ, We previously represented (Distance [(xᵢ, yⁱ), (X_{new}, Y_{new})]dᵢ)=Dᵢ−dᵢ, the uncertainty distance. The convergence algorithm also can calculate an RMS margin, as a difference between the current iteration's uncertainty distance RMS measure and the previous iteration's uncertainty distance RMS measure.

During an iteration, the convergence algorithm can use gradient descent to direct motion of the estimated location toward a beacon. In one example of gradient descent, the convergence algorithm calculates a quadratic cost function for an individual beacon i using the expression Dᵢ−dᵢ:

Costᵢ=(Dᵢ−dᵢ)²=(Xᵢ−xᵢ)²+(Yᵢ−yᵢ)² (4)

where Dᵢ is a vector with x and y components <Xᵢ, Yᵢ>, and dᵢ is a vector with x and y components, <xᵢ, yᵢ>. Cost function (4) calculates the square of a discrepancy vector between the estimated location and the beacon circumference. The average of all beacon costs per iteration reflects the accuracy of the location estimate, and is equal to the square of equation (3):

$$Average cost = \frac{1}{k} {\sum }_{i = 1}^{k} {( {X}_{i} - {x}_{i} )}^{2} + {( {Y}_{i} - {y}_{i} )}^{2} \qquad ( 5 )$$

A smaller average cost means that estimated location is, on average, closer to each beacon circumference, and, thus, more accurately multilaterated. Gradient descent iteratively reduces the average cost, improving the estimate. The algorithm takes the gradient of the cost function (4)

$$\begin{matrix}\frac{\partial }{\partial {X}_{i}} [ {( {X}_{i} - {x}_{i} )}^{2} + {( {Y}_{i} - {y}_{i} )}^{2} ] = 2 ( {X}_{i} - {x}_{i} ) & ( 6 ) \\ \frac{\partial }{\partial {Y}_{i}} [ {( {X}_{i} - {x}_{i} )}^{2} + {( {Y}_{i} - {y}_{i} )}^{2} ] = 2 ( {Y}_{i} - {y}_{i} ) & ( 7 )\end{matrix}$$

and, for each beacon during an iteration, uses it to calculate a new position estimate.

X₍ᵢ₊₁₎=Xᵢ+γ2(Xᵢ−xᵢ) (8)

Y₍ᵢ₊₁₎=Yᵢ+γ×2(Yᵢ−yᵢ) (9)

where γ is a learning rate, and 2γ is the parameterized step rate. Multiplying the gradient term by the learning rate ensures that the algorithm converges correctly. As the algorithm iterates, the discrepancy (Dᵢ−dᵢ) shrinks in magnitude, lowering the average cost per beacon. As described above, iteration concludes when the algorithm reaches a convergence condition. Equations (8) and (9) closely resemble equations (1) and (2) for a parameterized step rate 2y=½, where

$$( {X}_{1} - {x}_{1} ) = ( \frac{{x}_{1} - X}{{D}_{1}} ) ( {D}_{1} - {d}_{1} ) and ( {Y}_{1} - {y}_{1} ) = ( \frac{{y}_{1} - Y}{{D}_{1}} ) ( {D}_{1} - {d}_{1} ) .$$

As discussed earlier, a smaller parameterized step rate may result in a more accurate position estimate, but requires more iterations of the algorithm. A larger parameterized step rate requires fewer iterations of the algorithm, but may result in a less accurate position estimate.

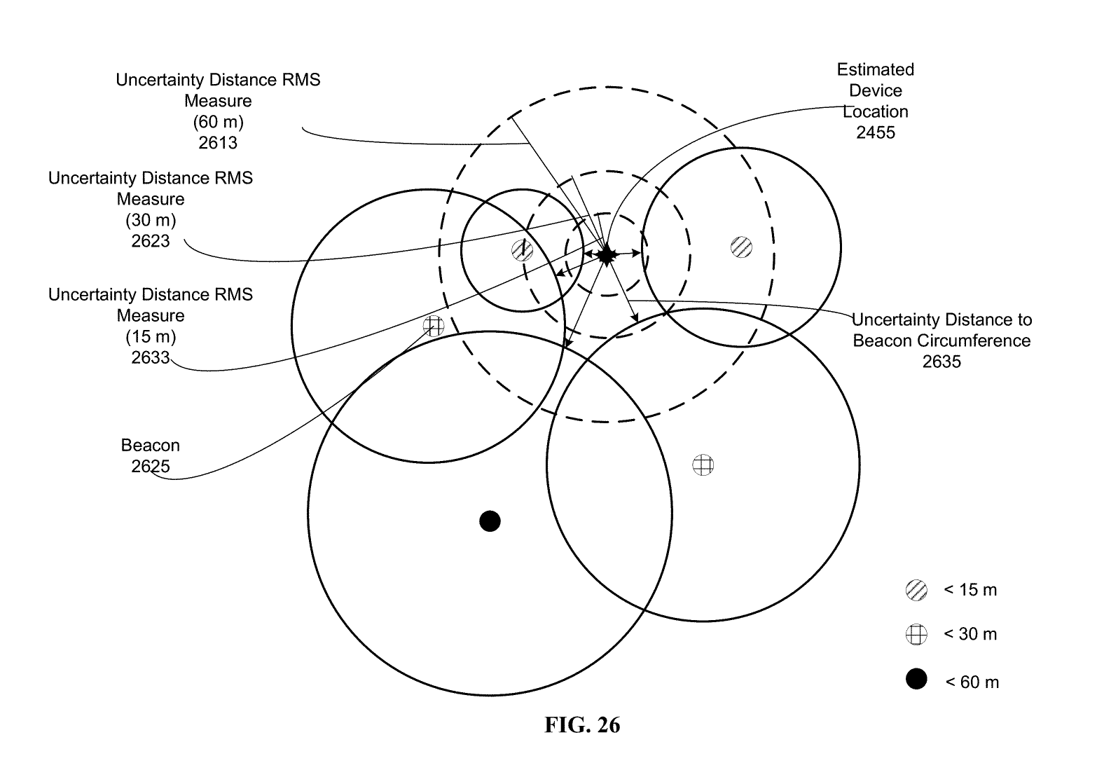

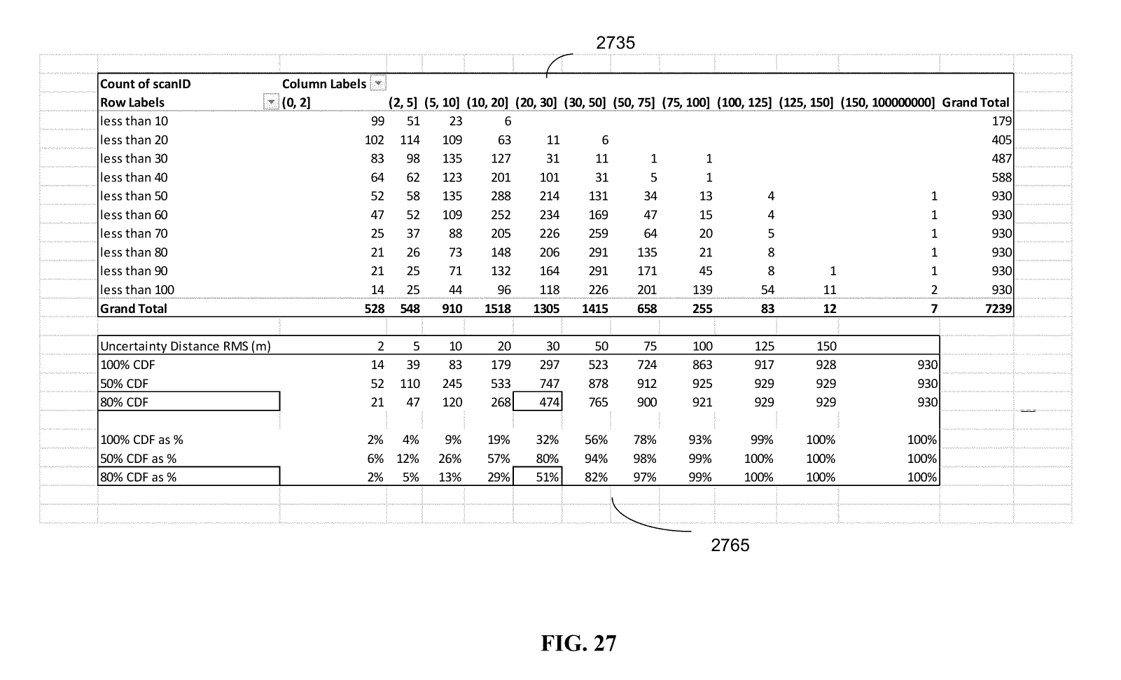

During development, uncertainty distance measures were calculated between individual final estimates and circumferences around individual beacons used in the multilateration. The uncertainty distance measure between a final estimate and a beacon i is the magnitude of the uncertainty distance between them and is expressed \sqrt{(D₁−dᵢ)²}. Distributions of beacon counts were compiled in uncertainty distance range buckets such as (20 to 30] meters. In most rows of FIG. 27, there are 930 observations. There are uncertainty distance range buckets such as (20 to 30] meters. Consider the less than 80 percent row. Buckets in the 80 percent row represent the minimum uncertainty distance from the final estimate needed to capture circumferences of up to 80 percent of the beacons used in the multilateration. For instance, in FIG. 26, with five beacons used, of which four had uncertainty distances less than or equal to 30 meters 2623. One beacon, to the bottom left, had an uncertainty distance greater than 30 meters. The estimated device location 2455 would belong in the less than 80%, (20-30 m] bucket and in a bucket in the 100%, (30-40 m] bucket. The distribution represented by buckets in the less than 80 percent row also can be expressed as a cumulative distribution function, as shown below the main table in counts and percentages.

FIG. 27 should be considered with integer division in mind, as not all rows have 930 observations. In the less than 10 percent row, only 179 observations had enough observed beacons, more than 10, to produce a distribution of uncertainty distances such that less than 10 percent of the beacons (at least one beacon) fell into a particular distribution range. There were not any observations in which less than 10 percent of the beacons used (e.g., one or two beacons) had uncertainty distances were calculated to be more than 20 meters.

In the less than 80 percent row of FIG. 27, the cumulative distribution function (CDF) for up to 30 meters has 474 of 930 observations in buckets up to 30 meters, for 51 percent. That is, in slightly more than half of the observations, up to 80 percent of the beacons were in buckets of uncertainty distances less than or equal to 30 meters. This led to a selection of 30 meters uncertainty distance, applied to 80 percent of calculations involving observed beacons, as a threshold for reporting a visitor's location to interested store operators at the mall. Estimates that have uncertainty distances worse than this criteria can be withheld from visitor location reporting to interested stores at the mall. This does not exclude a visitor from location reporting, as new scans are frequent, such as every six seconds, and the calculations resulting from successive scans are independent of one another. Nor does it exclude the estimated location from all uses, as time in a mall is of interest, even when a location is inaccurate. Location during an inaccurate scan can, for dwell time and other purposes, be interpolated to reasonably accurate calculated locations.

Other thresholds can be used, which combine a CDF distance and percentage of beacons, or which are selected based on experience. For instance, a distance of 10, 15, 20, 25, 30, or 35 meters can be used or in a range between any two of these distances. A percentage of beacons with an uncertainty distance less than (or equal) to the selected distance can be 60, 70, 80 or 90 percent or in a range between any two of these percentages.

Unlike closed form solutions, the technology disclosed multilaterates a location estimate for the mobile device from an arbitrary number of beacon signals, even in the face of inconsistent data. Inaccurate distance estimates would confound a closed form solution. Once four or more signals are used, inconsistent estimated distances are virtually certain to arise, because only three distance measurements are needed to trilaterate a position in 2D space. Using the convergence algorithm's numerical method instead, a device position can be multilaterated in many types of environments with different factors affecting signal attenuation. In addition, the convergence algorithm can be modified to include different methods of filtering beacon signals and to stop iteration when it meets different convergence conditions. These factors make the disclosed technology more adaptive than closed-form multilateration methods.

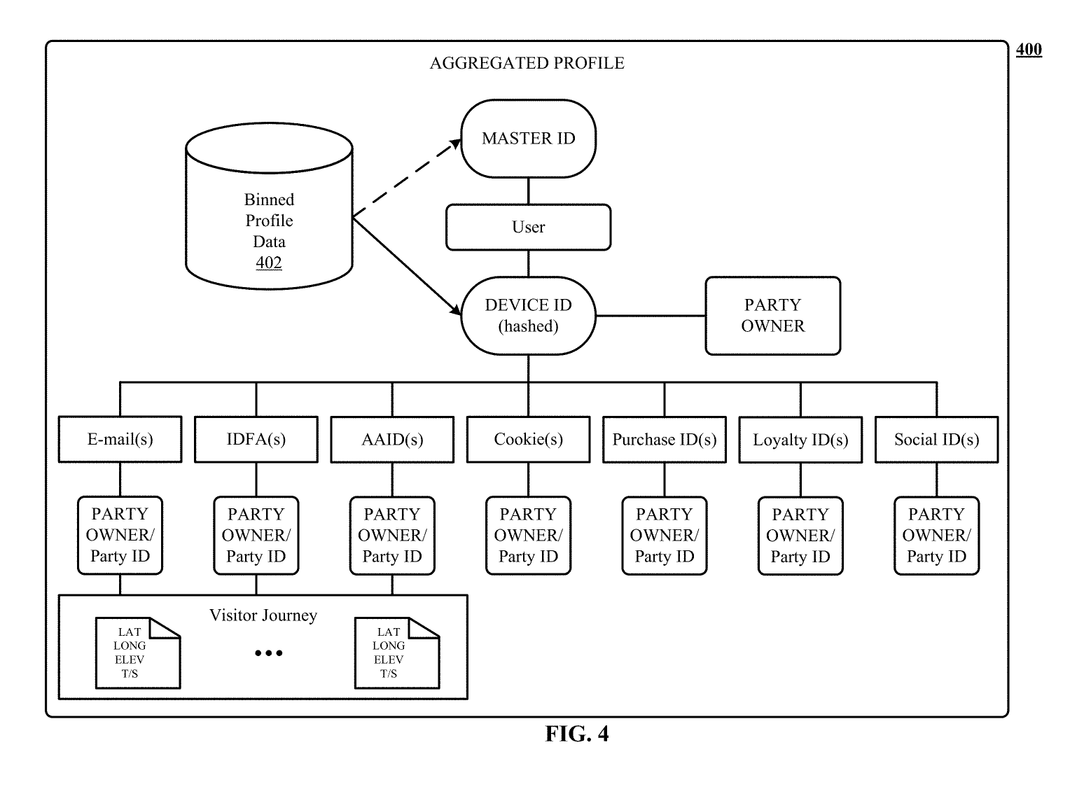

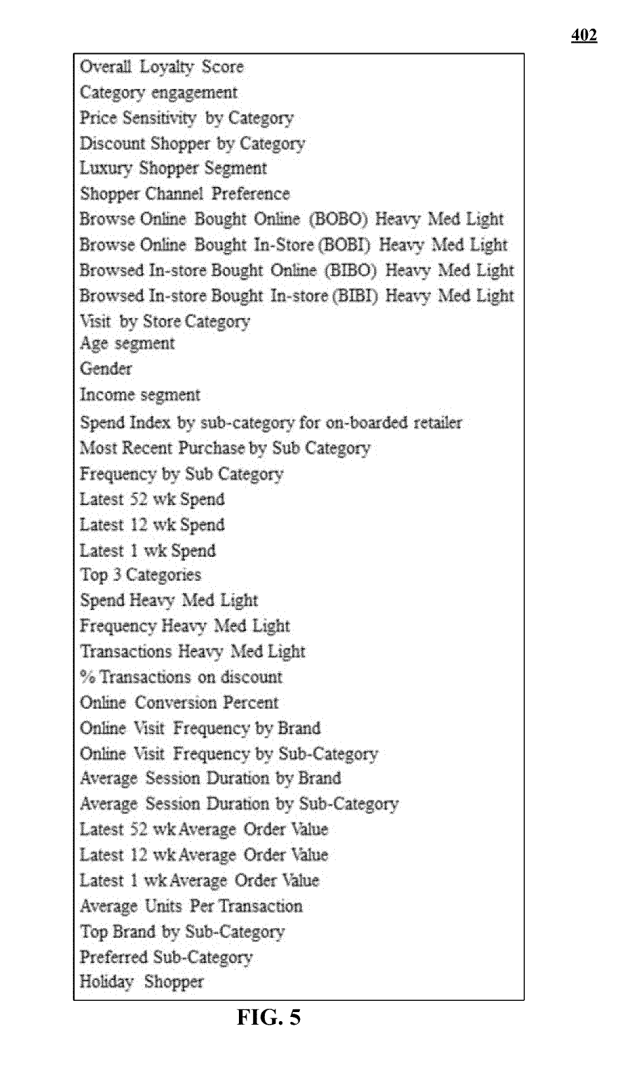

FIG. 4 shows one implementation of an aggregated profile 400 with a master identifier (ID) created for the visitor. When profile and/or location information about a user (or shopper or visitor) is received by the system 100 from one or more data sources, it is assigned a device ID and stored. Device ID uniquely identifies the user associated with the information. The device ID is further tagged with a party owner ID, which identifies the source of the information (e.g., the retail store that provide the information). In some implementations, device ID can be produced by hashing an internal ID used by the retail store to internally identify the user. This way the identity of the user is preserved and is not exposable via the system 100.

In addition, the system 100 assigns a master ID to the device ID. Master ID is used by the system 100 to manage the user's identity and information across many different data sources and retail stores. Binned profile data 402 is linked to the master ID.

Profile and/or location information about the user can be encoded using fields such as e-mail, IDFA, AAID, cookie, purchase ID, loyalty ID, or a social media ID. When the system 100 receives values for these fields, it identifies the source of the value using a party owner ID and also assigns a unique party ID to the value. In some implementations, multiple instances of the same value are received from different sources, such that each value is assigned a different party ID and a corresponding party owner ID.

Also, the e-mail, the IDFA, and the AAID fields are used to track the user's journey, according to some implementations.

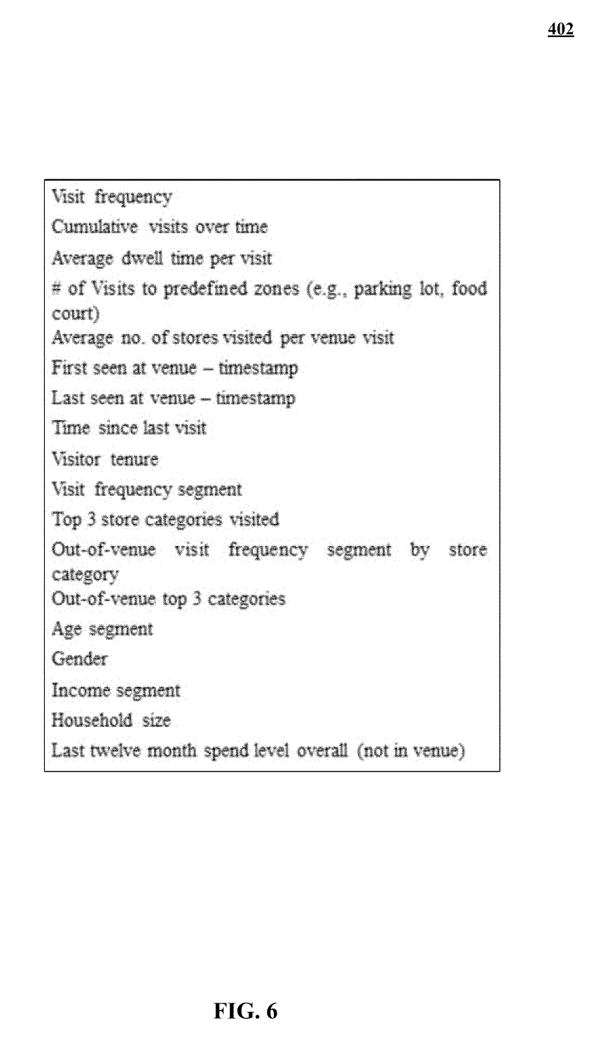

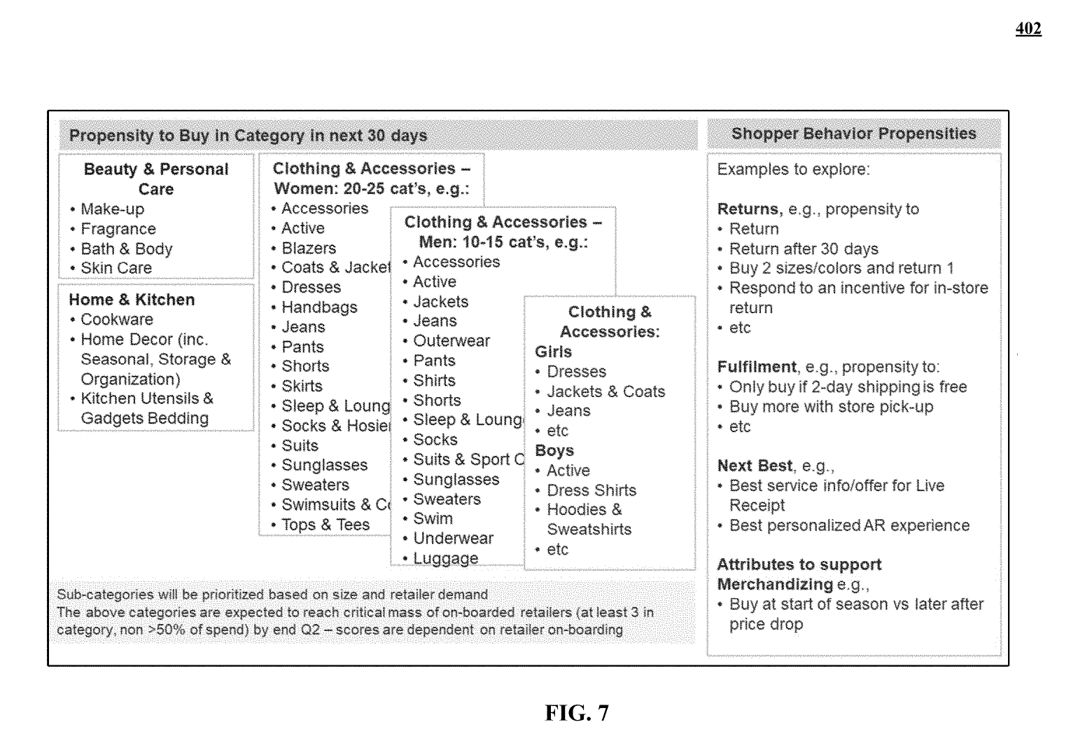

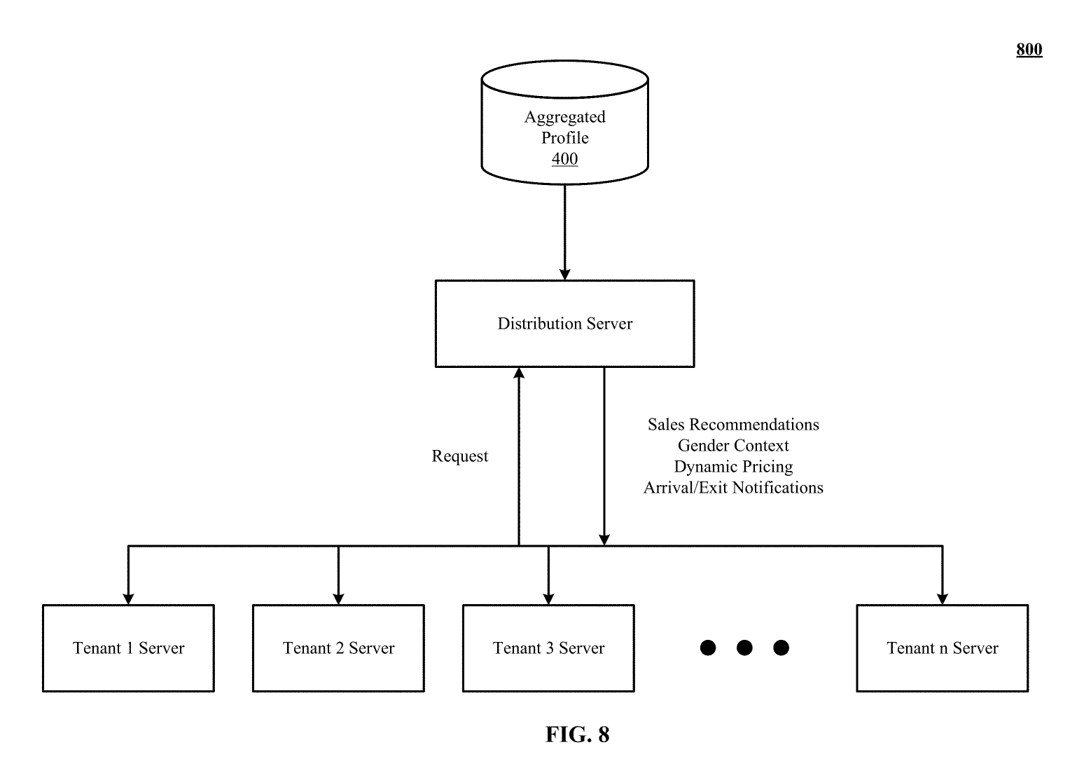

FIG. 5 lists some examples of retailer-related attributes that are included as binned profile data in the aggregated profile 400. FIG. 6 lists some examples of venue-related attributes that are included as binned profile data in the aggregated profile 400. FIG. 7 shows some examples of shopper propensities that are included in the aggregated profile 400.

Regarding dinned profile data 402, it includes tenant-specific binned data individualized for the visitors that represents time-based events in time window bins organized into event categories (e.g., most recent purchase by sub category in FIG. 5). It also includes aggregated data individualized for the visitors that also represents time-based events in time-window bins organized into event categories, aggregated across at least the tenants (e.g., latest 52 week spend, latest 12 week spend, latest 1 week spend in FIG. 5). It also includes pre-calculated intent propensities organized by the event categories, generated from the tenant-specific and aggregated data (e.g., return propensity, fulfillment propensity, next best propensity in FIG. 7). The aggregated data individualized for the visitors further represents time-based events in time-window bins organized into event categories, collected from non-tenant entities (e.g., average dwell time per visit at a venue in FIG. 6). The aggregated data individualized for the visitors further includes individual visitor opt-in permissions for location tracking and for messaging organized by data source

FIG. 8 illustrates a distribution server that uses the aggregated profile 400 to send sales recommendations, gender context, dynamic pricing, and/or arrival/exit notifications to participating tenants of the physical venue in response to tenant requests. In other implementations, the participating tenants are participating independent retail stores that are not in a tenant-landlord relationship. The distribution sever can use the visitor journey information encoded in the aggregated profile 400 to report to servers representing the participating tenants of arrival of the visitor, accompanied by a profile of the visitor and tenant-specific and aggregate intent propensity information. The reporting can include a visitor name and other personally identifiable information. The reporting can include a visitor photograph and other personally identifiable information. The reporting can include a unique identifier but not a visitor name or photograph.

As discussed above, binned profile data 402 also includes at least one identified intent of the visitor upon arrival at the venue. The distribution sever can use the intent information encoded in the aggregated profile 400 to report to servers representing the participating tenants of the identified intent. In other implementations, based on an entitlement being fulfilled at the venue, the distribution sever can use the intent information encoded in the aggregated profile 400 to report to servers representing the participating tenants of the identified intent.

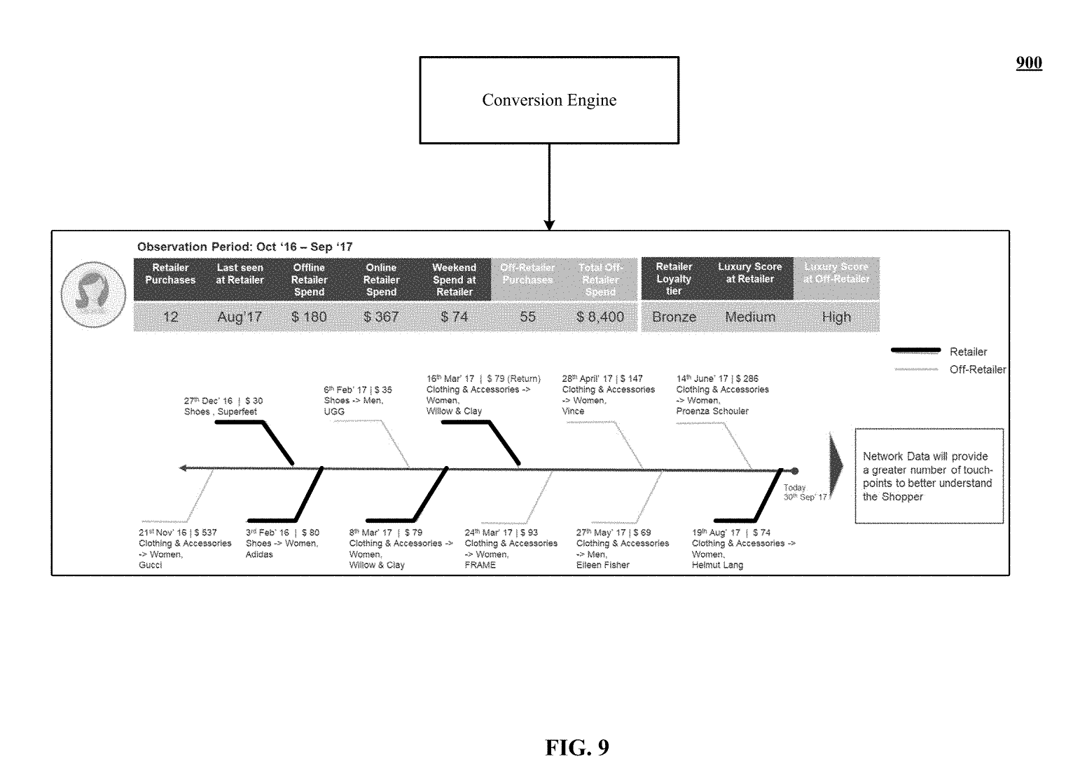

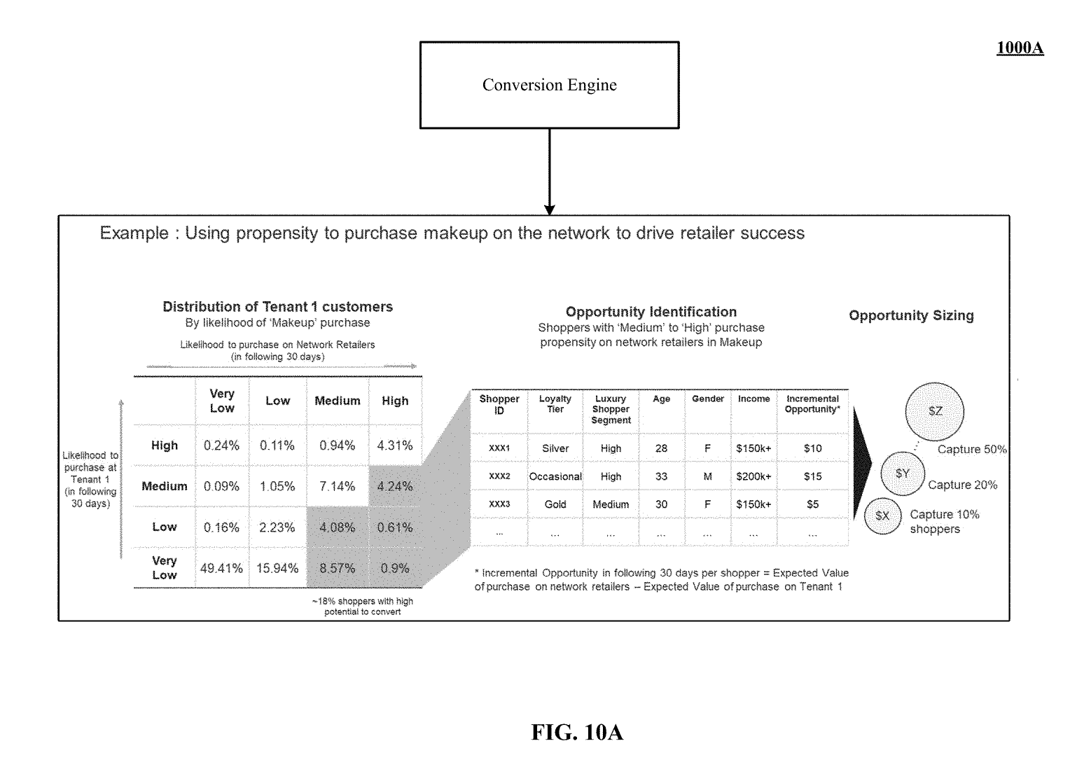

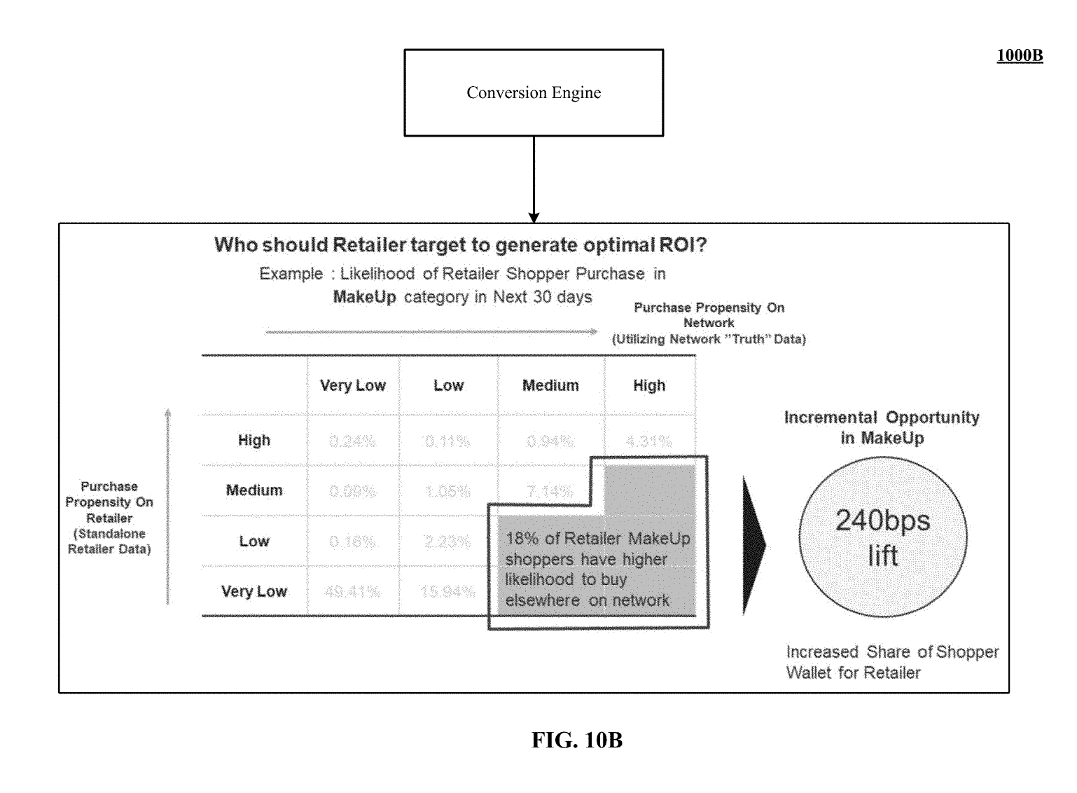

FIGS. 9, 10A and 10B show a conversion engine that uses the aggregated profile of FIG. 4 to identify in-retailer and overall purchase propensities for converting shoppers to in-retailer purchases. In the illustrated embodiment, the system 100 determined that the in-retailer categorization of the shopper is “bronze” based on the shopper's purchase history and spending patterns just at a given retailer. However, upon evaluation of the shopper's purchase history and spending patter at other retailers, the system 100 determines that the shopper is a “high” shopper who has spent much more at the other retailers. The given retailer is informed of this insight via the distribution server and given an opportunity to attend to or target the shopper with more vigor so as to capture more of the shopper's business.

In FIGS. 10A and 10B, system 100 identifies shoppers that have a high potential to convert to a given tenant. System 100 does this by determining that certain shoppers spend much more on a product (e.g., makeup) at other retailers and spend much less on the same produce at the given tenant. The given tenant can be informed of this insight via the distribution server and given an opportunity to attend to or target such shoppers with more vigor so as to capture more of the shopper's business. In implementations, such an insight is provided proactively using the shoppers' purchase history so that the given tenant can launch a marketing or advertising campaign aimed at such high-value shoppers.

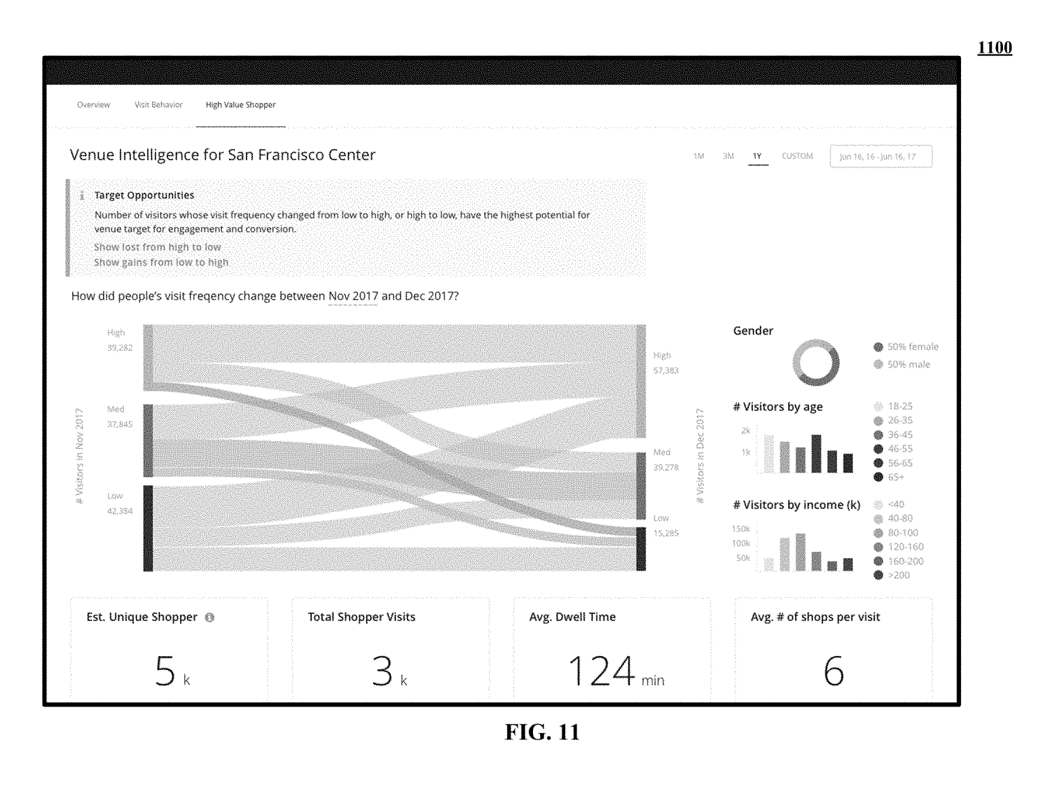

FIG. 11 depicts one implementation of a dashboard that graphically presents various venue intelligence metrics to a venue operator. The time period for this display is one year. The main graphic in the display shows how visit frequencies change between November 2017 and December 2017. The overall trend is that more visitors converted from the low to the high visitation frequency category, which would be expected with the approach of holidays. Additional graphics indicated the gender, age and income of visitors. Statistics across the bottom indicate the estimated number of unique shoppers, the total shopper visits, the average time at the venue, and the average number of shops visited per journey. Aggregated profiles for these 5000 shoppers can be configured to retain binned data of this sort. Alternatively, event records can be queried to produce this kind of display.

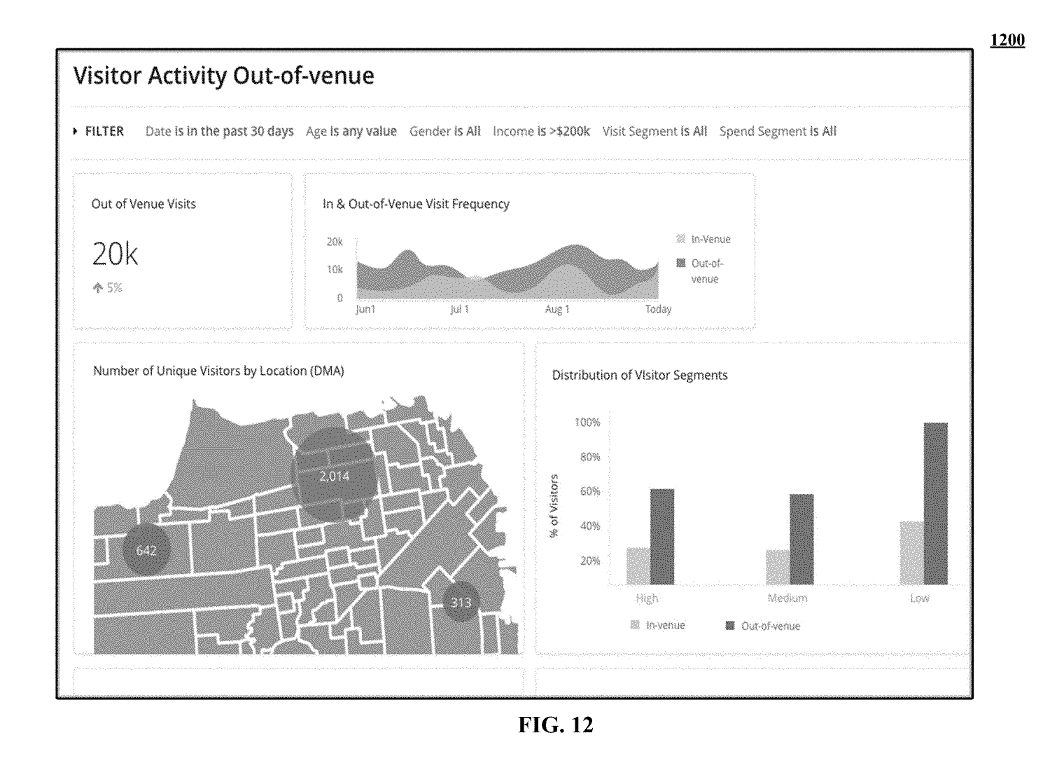

FIG. 12 illustrates one implementation of a dashboard that graphically presents various visitor activity metrics to a venue operator. This display compares in-venue to out-of-venue activity. This display is filtered by time and income. It reflects 20,000 out-of-venue visits in the past 30 days by persons who also visited the venue, which is a 5% uptick from an earlier month. A wave graph for June through December shows the relative frequency of in- and out-of-venue visits by these known visitors. The graph in the bottom left corner indicates where some of the visitors came from. The final graph indicates a distribution of visitor segments. Because this display shows daily or weekly frequencies, it is constructed from event records.

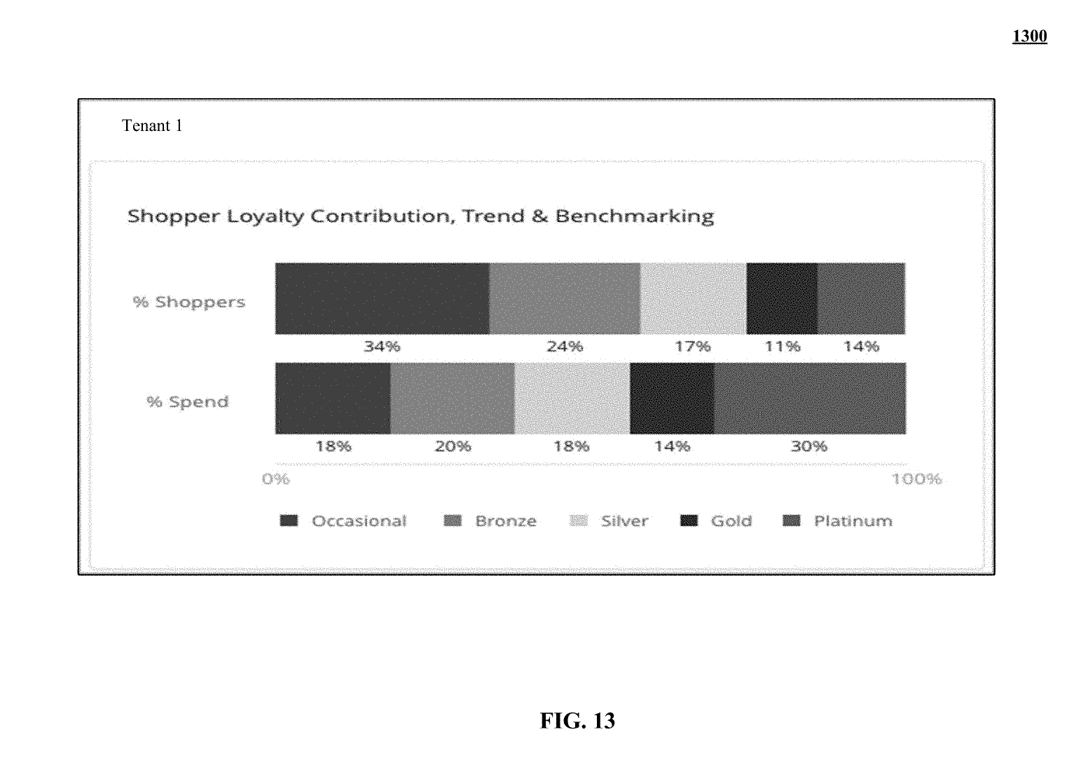

FIG. 13 is one implementation of a dashboard that graphically depicts various shopper attributes across a plurality of shopper stratums. This graph indicates the relative revenue produced by visitors with different ranks of shopper loyalty. This graph organizes shoppers by occasional, bronze, silver, gold and platinum categories. While the platinum category accounts for only 14% of the shoppers, those shoppers generate 30% of this retailer's revenue, at least at one location. A dashboard like this encourages devotion of extra attention to platinum shoppers.

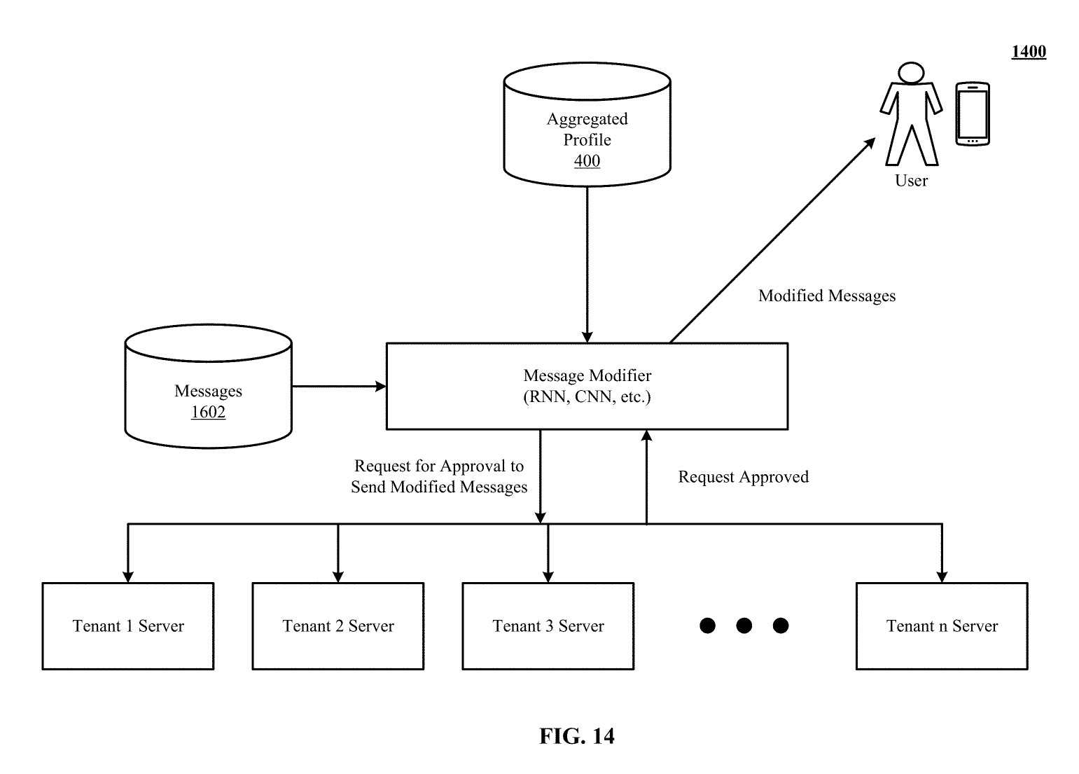

FIG. 14 illustrates a message modifier that uses the aggregated profile 400 of FIG. 4 to determine shopper intent and propensities, and in response, to modify messages and engagement schemes used by the tenants to interact with the visitors. The technology disclosed can be applied to tenants working with a common venue operator, or to independent retail stores in a shopping district who own their own buildings or have different landlords, or to sub locations within a single venue, such as exhibit areas in a museum or wings of an historic or public venue. Messages or message templates 1602 are selected or received by a message modifier. The identity of a target user or visitor is conveyed by the message modifier, along with information from the aggregated port profile 400, to servers representing multiple tenants at the venue. An artificial intelligence system may further process data regarding recent activity by the user, in view of binned data in the aggregate profile. This processing can modify intent propensities precalculated in the binned data to take into account the course of a journey or recent online browsing. Modified intent propensities can be part of the data conveyed to the servers representing multiple entities. The message modifier determines which of the proposed or candidate messages from tenant servers will be sent as modified messages to the user or visitor.

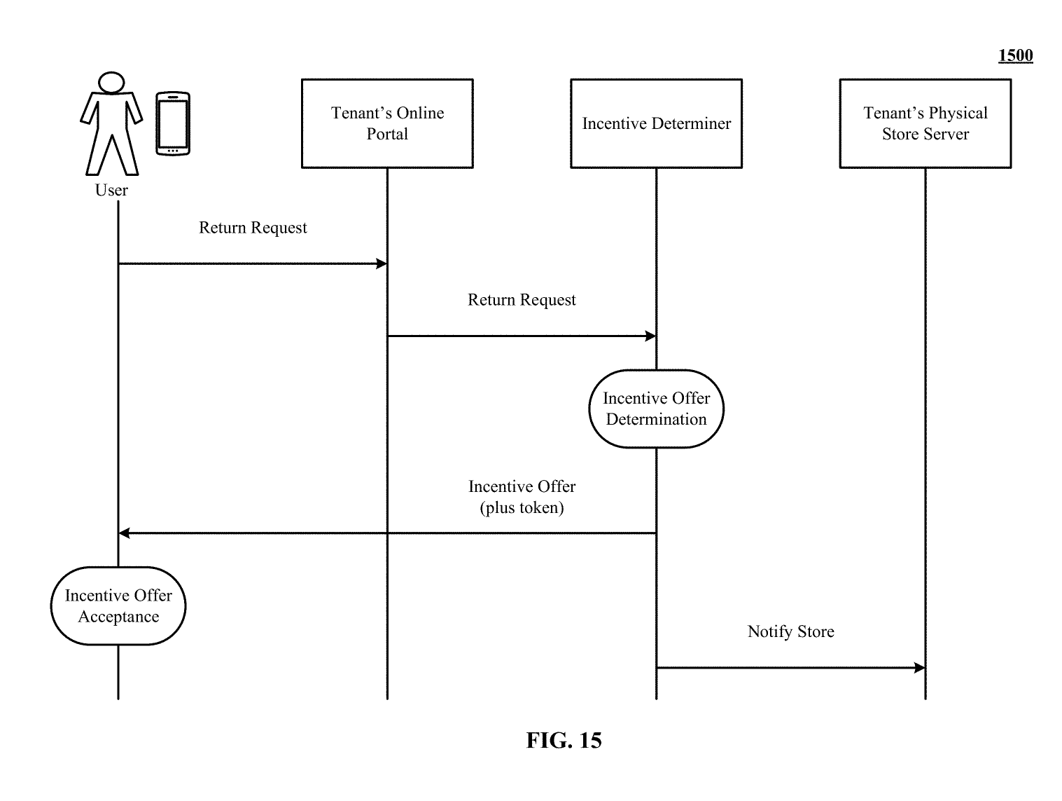

FIG. 15 is a message sequence chart of determining an incentive offer for a shopper using the aggregated profile 400 of FIG. 4 and using the incentive offer to cause the shopper to return goods purchased online at a physical location instead of returning the goods by shipping. It is expensive for a retailer to accept returns by shipping. Sometimes, the return destination is different than the fulfillment destination. In those instances, a restocking fee is charged by the fulfillment agent. It is likely to be less expensive for the retailer to exchange goods at a physical location, for instance by providing a better fitting size. The opportunity to convert a return by shipping to a return in-store arises when a user makes return request to an online portal. The online portal accesses an incentive determination engine. The incentive determination engine uses data in the aggregate profile 400 to assess how much incentive, if any, is likely to convert the user from a return by shipping to a return in store. The aggregated profile 400 contains historic data on propensities of the user to return goods in-store and is liked to additional data, including event data. It also contains binned historic data on return patterns. The incentive determination engine also has access to return processing costs. Reduced return processing costs and opportunities to make an exchange or sell additional goods to the user can be taken into account by the incentive determination engine. Incentive determination engine calculates a maximum incentive for in-store return. This incentive may be modified based on historical data regarding propensities of a particular user. Once an incentive offer determination is made, the offer is returned the user. Upon acceptance of an offer, the online portal for the incentive engine notifies the location at which the return is to take place and provides a token, such as a scannable code, to the user to present at return.

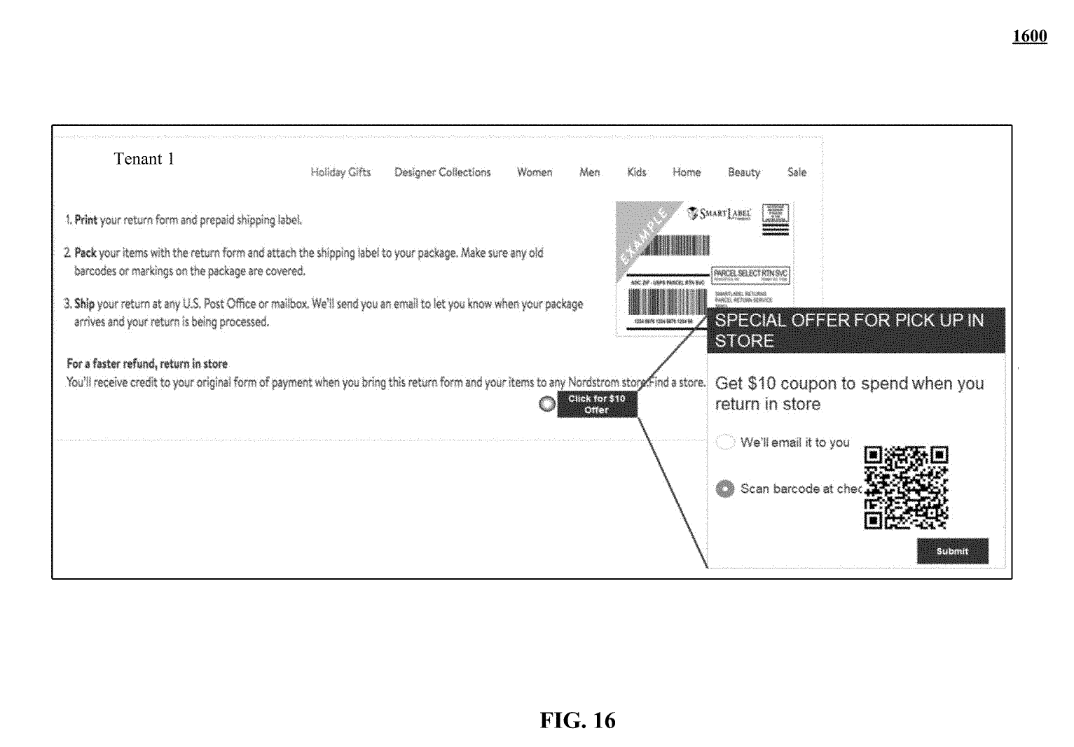

FIG. 16 shows one example of the incentive offer described in FIG. 15. This offer provides a $10 coupon towards additional purchases and a scannable code that can be associated with the return. The scannable code is a token that allows a point-of-sale system to readily accept the return. It also can be used as a coupon, once the return is completed.

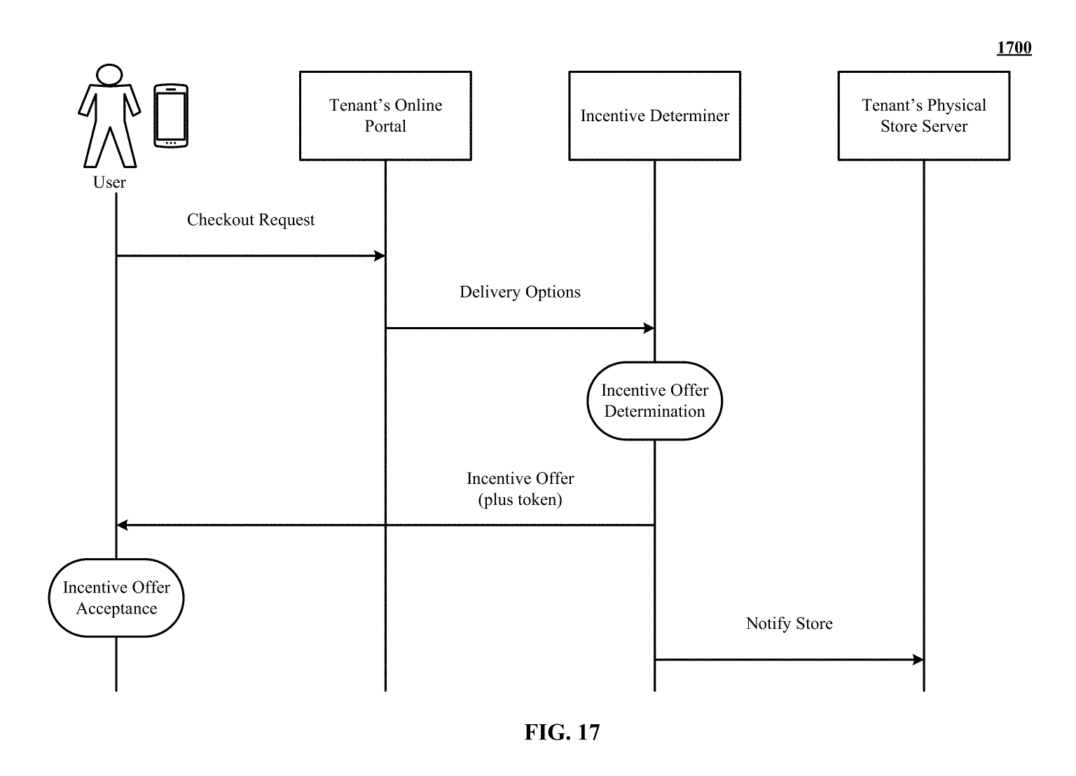

FIG. 17 is a message sequence chart of determining an incentive offer for a shopper using the aggregated profile 400 of FIG. 4 and using the incentive offer to cause the shopper to pick up goods at a physical location rather than request shipping. This works much the same way as returning goods purchased online at a physical location, instead of by shipping. Instead of returning goods, for example for exchange, the user picks up purchased goods. The physical location is responsible for picking the goods and making them available at a pickup counter. In the figure, the online portal, at checkout request, offers the option of in-store pickup. In incentive determination engine uses data in the aggregate profile to assess how much incentive, if any, is likely to convert the user from fulfillment by shipping to picking up goods at a physical location. The aggregated profile contains historic data on propensities of the user to pick up goods from a physical location that are selected and paid for online. Incentive determination engine also has access to fulfillment by shipping costs. Reduced fulfillment costs and opportunities to sell additional goods the user can be taken into account by the incentive determination engine. Incentive determination engine calculates a maximum incentive for in-store pickup. This incentive may be modified based on historical data regarding propensities of a particular user. Once in all incentive offer determination is made, the offers returned to the user. Upon acceptance of an offer, the online portal for the incentive engine notifies the location at which the goods are to be picked up to pull the goods from inventory. It provides a token to the user to present upon arrival at the pickup desk.

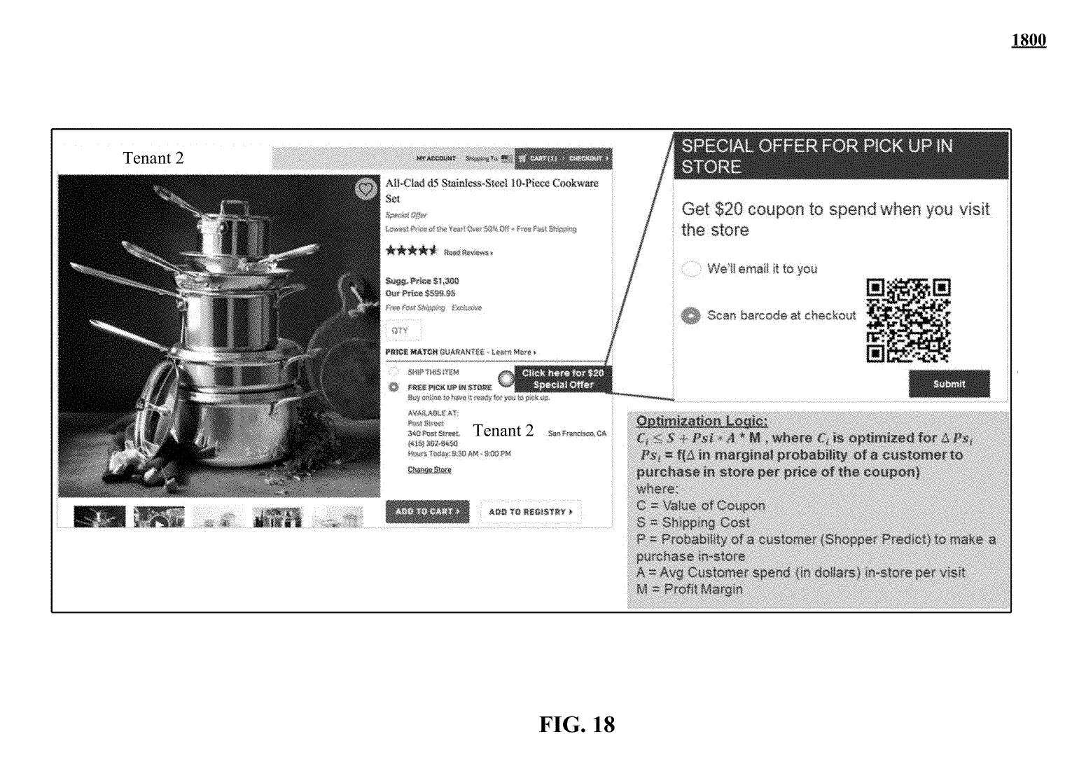

FIG. 18 shows one example of the incentive offer described in FIG. 17. The optimization logic appears in the bottom right-hand corner. The cookware goods being purchased appear prominently in a photograph. The incentive in this example is a $20 coupon to spend while visiting the store. The scannable barcode acts as a token for pickup and can serve as a coupon once the pickup is complete.

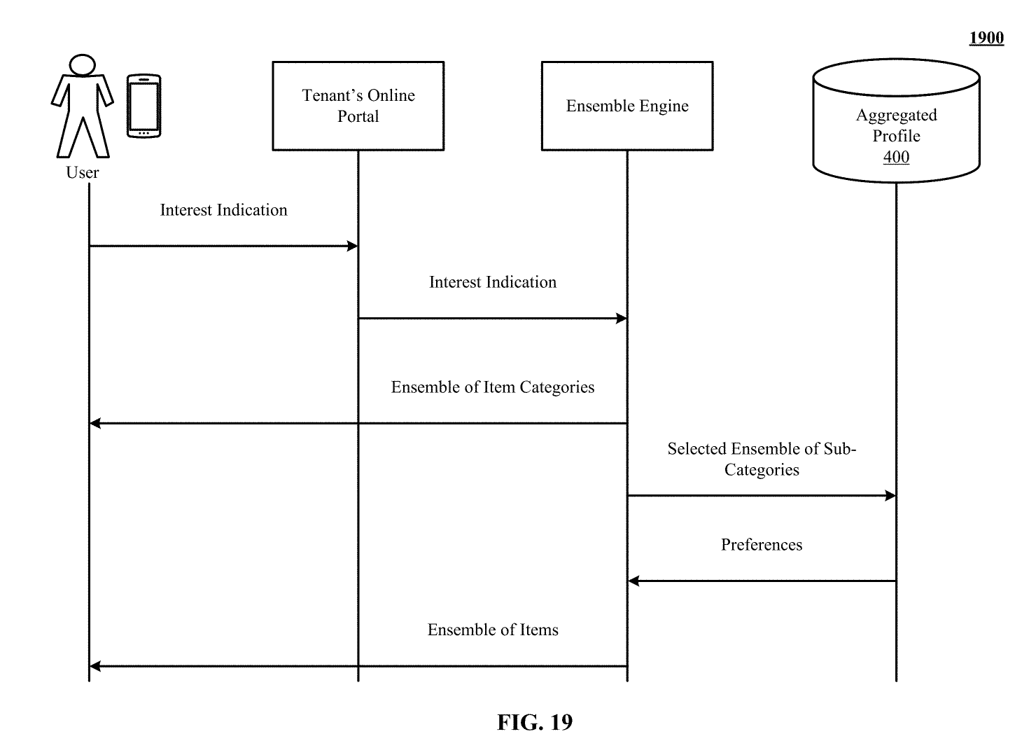

FIG. 19 depicts a message sequence chart of enhancing a user browsing experience using an ensemble engine that generates product recommendations based on a shopper's purchase history, intent and propensity data identified in the aggregated profile 400. When the user accesses a tenant's online portal (e.g., website) and indicates an item of interest, the portal pings an ensemble engine with the item of interest. In response, the ensemble engine provides to the user, via the portal, an ensemble of item categories that complement the item of interest. Based on the user's selection of certain ensemble of sub-categories, the ensemble engine looks up the sub-categories in the aggregated profile 400 and retrieves for user preferences. These include category preferences of the user among recommended categories in the ensemble of item categories, feature preferences of the user that apply to the recommended categories, and feature preferences to select items. The ensemble of items selected using the determined category and feature preferences of the user are then presented to the user by the ensemble engine via the portal.

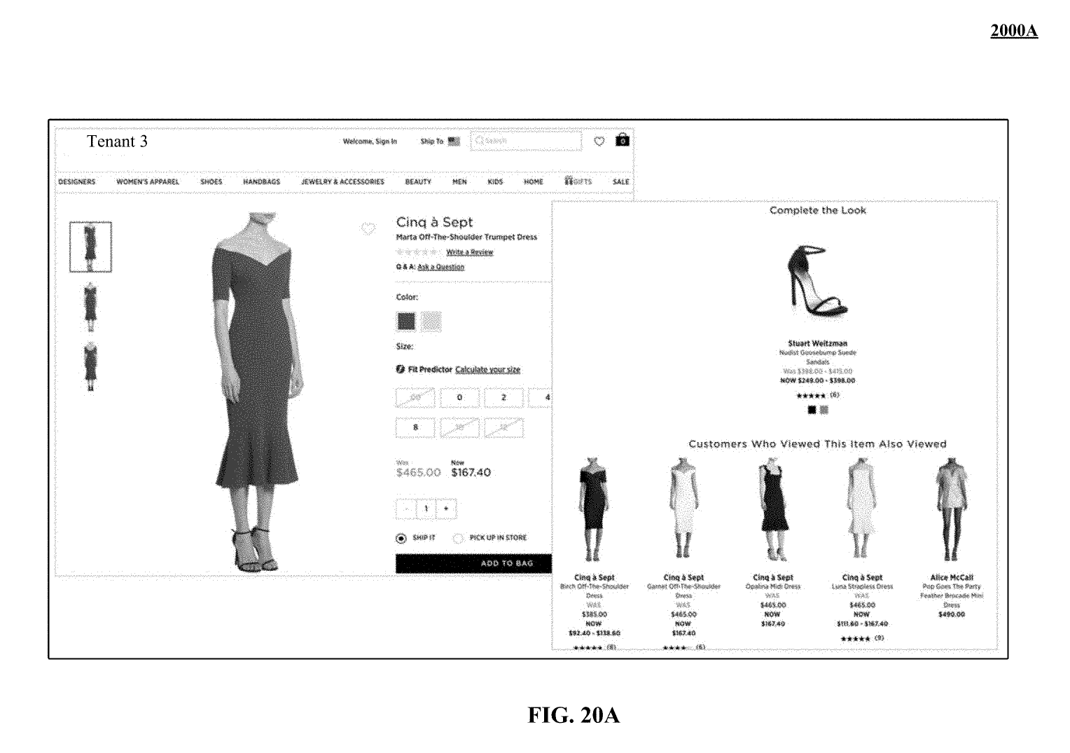

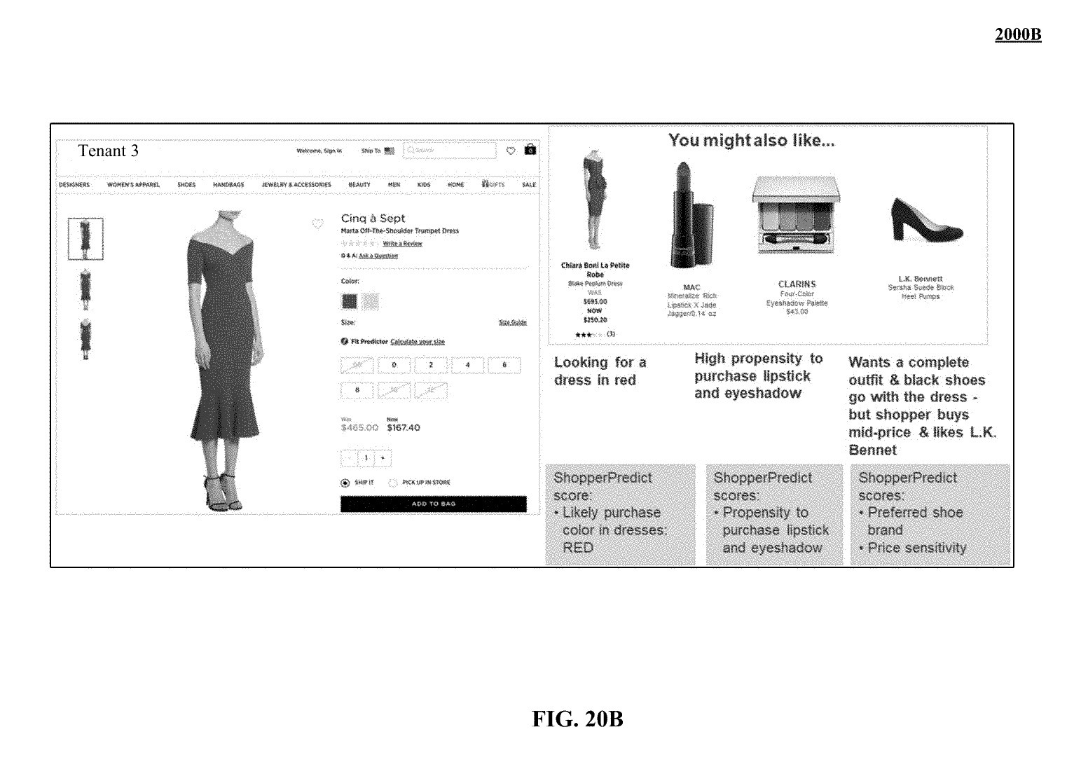

FIGS. 20A and 20B show one example of how the user browsing experience is enhanced by the ensemble engine of FIG. 19. In FIG. 20A, user experience without use of the ensemble engine is shown. In FIG. 20A, the user selected a red dress and is recommended a high heel shoe to complement the red dress. In FIG. 20B, the user experience is enhanced by invoking the ensemble engine. Upon invocation, the ensemble engine determines from the aggregated profile 400 that the user prefers low heel shoes and some other make up accessories (e.g., lipstick, preferred shoed brand, price sensitivity). Based on this information, the recommendations to the user are revised to include product that match the user's preferences.

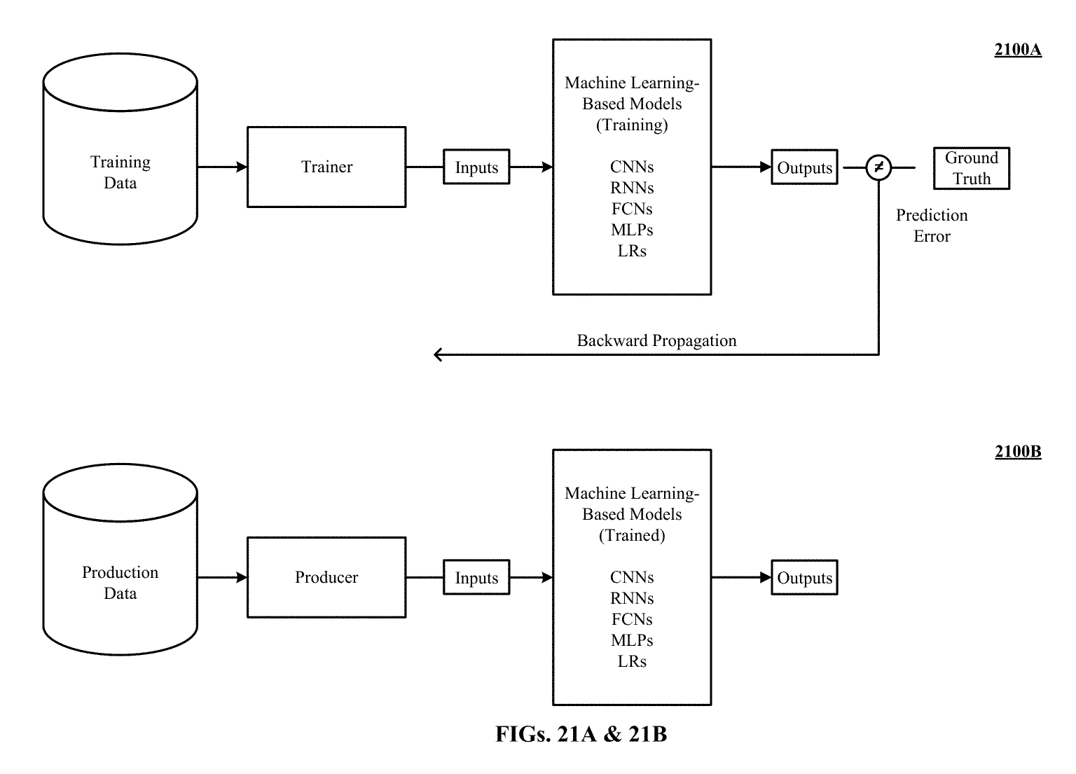

FIG. 21A shows one implementation of a training stage 2100A in which machine learning-based models are trained on training data to output user intent and propensity information. FIG. 21B shows one implementation of a production/inference stage 2100B in which trained machine learning-based models from FIG. 21A are used to evaluate production data and output user intent and propensity information. Examples of machine learning-based models include logistic regression-based models, convolutional neural network-based models, recurrent neural network-based models (e.g., models that use long short-term memory networks or gated recurrent units), fully-connected network-based models, and multilayer perceptron-based models.

In implementations, the machine learning-based models are trained to predict user intent and propensity. The training stage 2100A includes transforming time series of event data using a processor to form a training set (or data). Transformation includes binning hyper-location information by user from physical browsing by the user at a venue having multiple sub locations in time-oriented product category bins, further binning online browsing and consequent conversion history information of a user in time-oriented category bins, and further binning point-of-sale (POS) terminal information by user in the time-oriented category bins. The category bins can be hierarchically arranged from at least dozens of main categories through hundreds or thousands of conversion-specific items. The models are then trained on a combination of the binned online browsing and consequent conversion history, the PoS terminal information, and the hyper-location information to output category intent propensities on a per user basis. In some implementations, the binned purchase amount information is combined with the category purchase propensities and the models are trained using the combination to output an expected product category purchase value on the per user basis. In some implementations, the outputs are generated in dependence upon account seasonal factors.

At the production stage 2100B, the trained models are used to evaluate the production data and output intent and propensity data such as category intent propensities on a per user basis and expected product category purchase value on the per user basis.

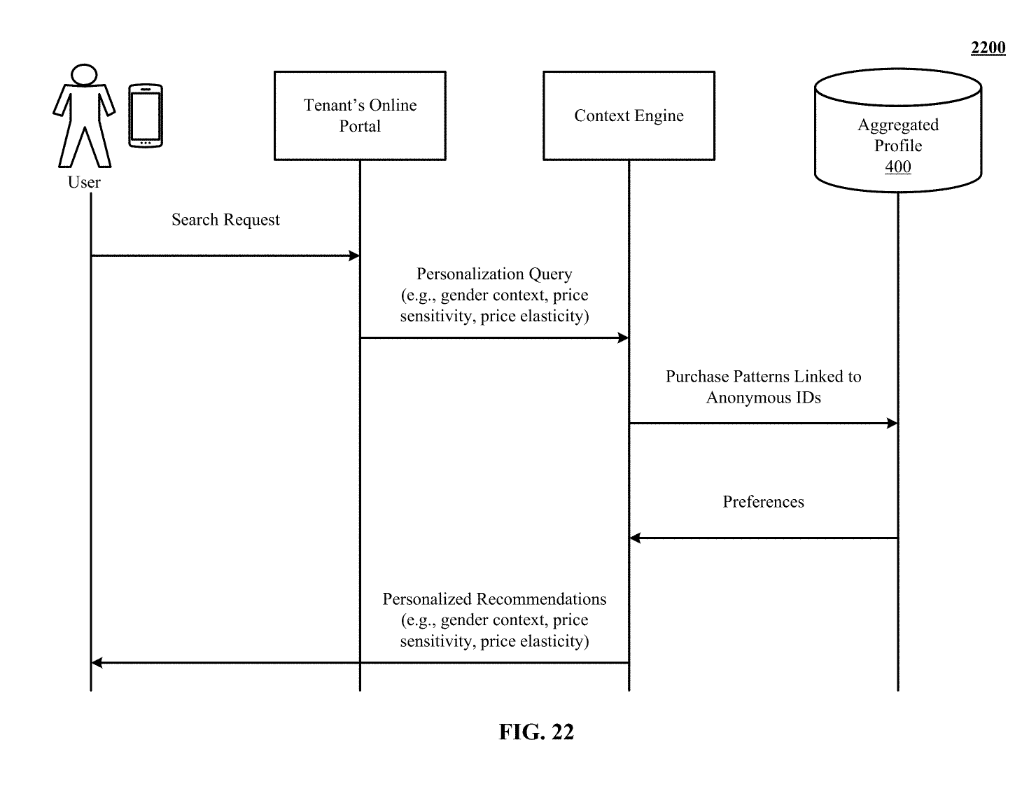

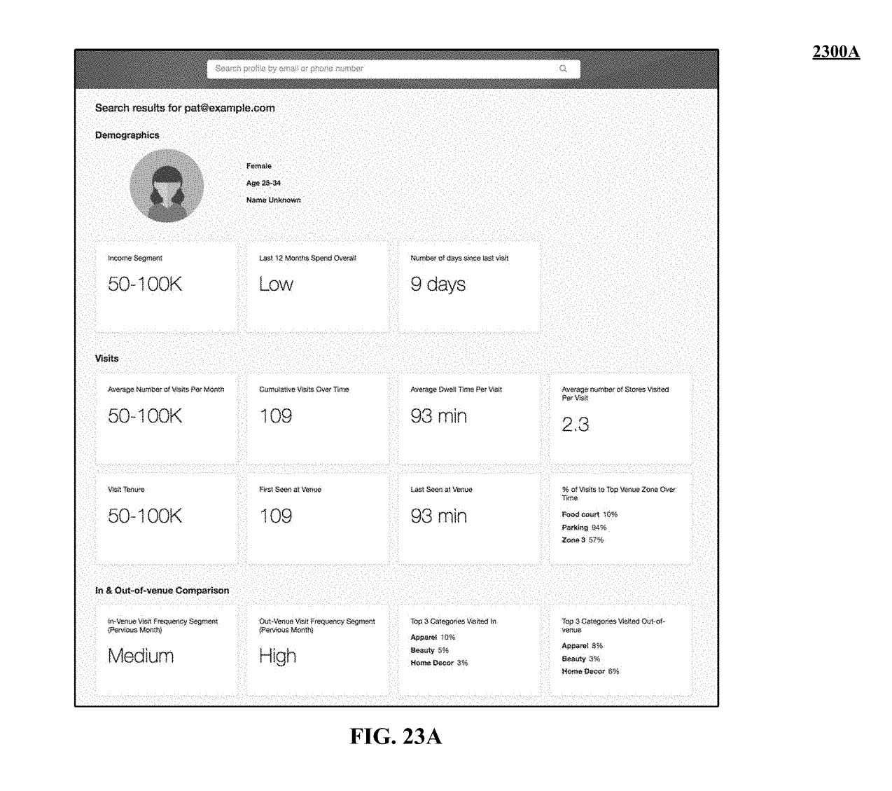

FIG. 22 is a message sequence chart of using the aggregated profile 400 to make personalized recommendations to a shopper. When the user accesses a tenant's online portal (e.g., web site) and searches for a product through a search request, the portal pings a context engine with a personalization query to request some additional context about the user. Examples of user context include gender context (i.e., the user is male or female), price sensitivity context (i.e., what price ranges the user usually makes purchase in), and price elasticity context (i.e., what kind of discounts will propel the user to make a purchase). In response, the context engine access the aggregated profile 400 using purchase patterns linked to an anonymous ID of the user and retrieves purchase preferences of the user from the aggregated profile 400. The context engine then determines personalized recommendations for the user, which are presented to the user via the portal.

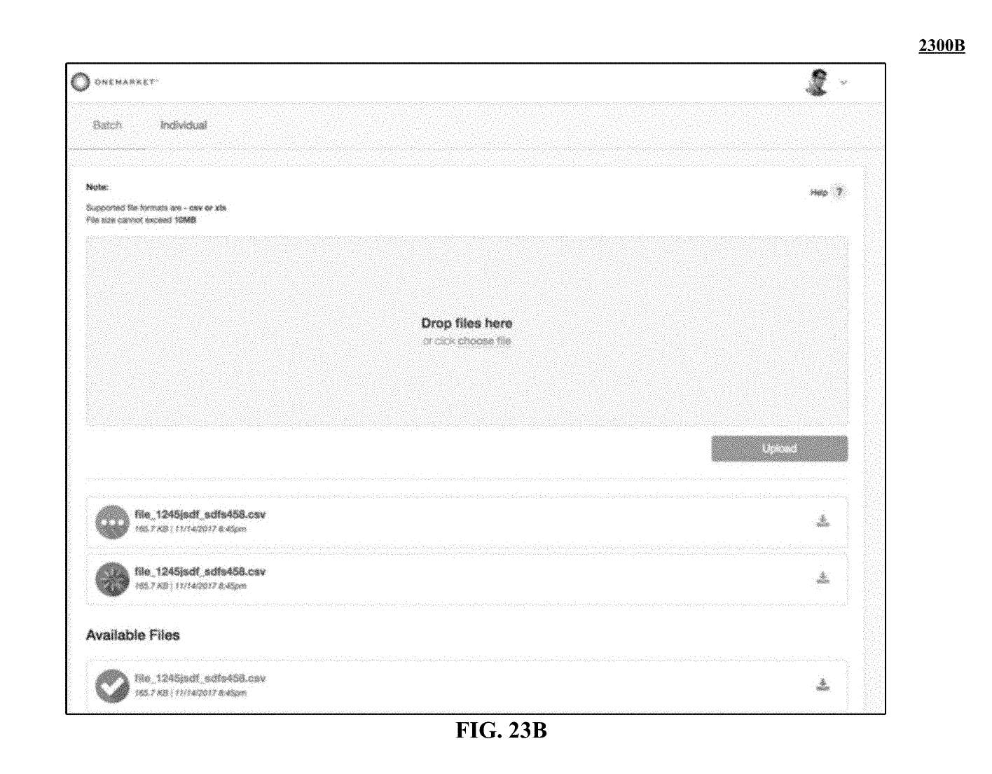

FIG. 23A shows one implementation of a shopper profile 2300A accessible to a retail store operator. Shopper profile 2300A includes various shopper metrics such as biographic information about the shopper, the shopper's income segment, the shopper's purchase history, the shopper's visit history, etc. FIG. 23B is one implementation of an interface 2300B that can be used by a retail store operator to request new or updated shopper profiles. In one implementation, the store operator can use a drag and drop feature to upload a list of shopper to the system 100. In response, system 100 can generate new or recent shopper profiles (such as shopper profile 2300A) for the shoppers identified in the uploaded list and present them to the store operator. The retrieval of a shopper profile can also be for an individual shopper, without the upload requirement.

### Computer System

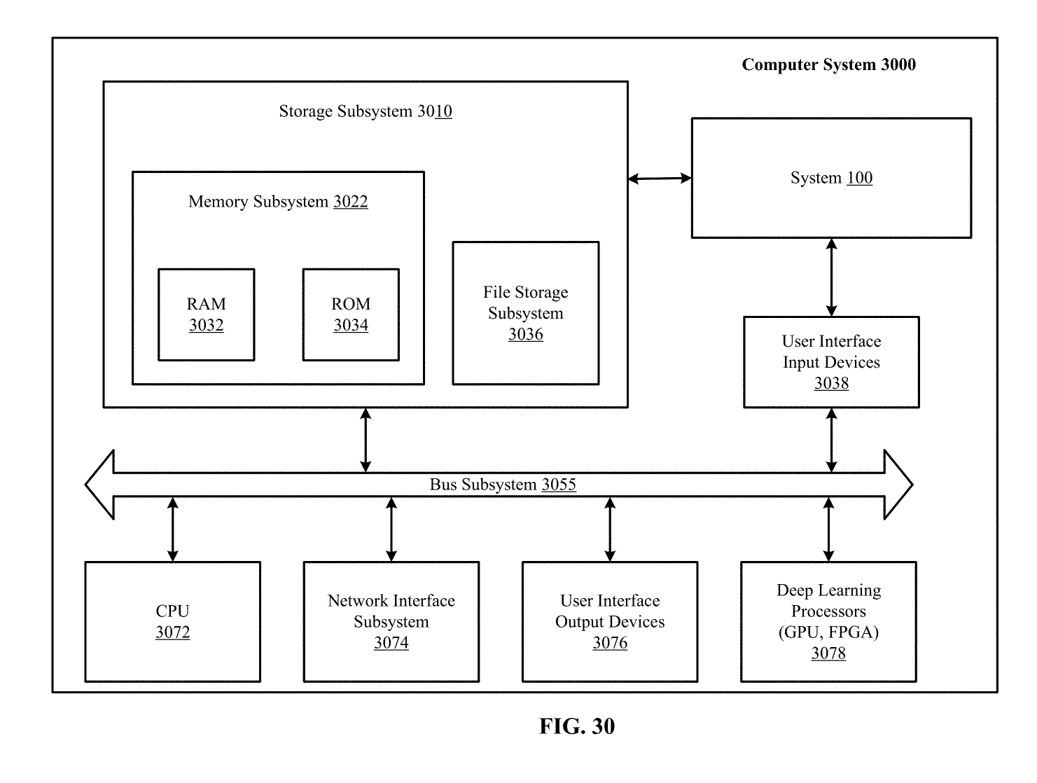

FIG. 30 is one implementation of a computer system 3000 that can be used to implement the technology disclosed. Computer system 3000 includes at least one central processing unit (CPU) 3072 that communicates with a number of peripheral devices via bus subsystem 3055. These peripheral devices can include a storage subsystem 3010 including, for example, memory devices and a file storage subsystem 3036, user interface input devices 2438, user interface output devices 3076, and a network interface subsystem 3074. The input and output devices allow user interaction with computer system 3000. Network interface subsystem 3074 provides an interface to outside networks, including an interface to corresponding interface devices in other computer systems.

In one implementation, the system 100 of FIG. 1 is communicably linked to the storage subsystem 3010 and the user interface input devices 3038.

User interface input devices 3038 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 3000.

User interface output devices 3076 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 3000 to the user or to another machine or computer system.

Storage subsystem 3010 stores programming and data constructs that provide the functionality of some or all of the modules and methods described herein. These software modules are generally executed by deep learning processors 3078.

Deep learning processors 3078 can be graphics processing units (GPUs) or field-programmable gate arrays (FPGAs). Deep learning processors 3078 can be hosted by a deep learning cloud platform such as Google Cloud Platform™, Xilinx™, and Cirrascale™. Examples of deep learning processors 3078 include Google's Tensor Processing Unit (TPU)™, rackmount solutions like GX4 Rackmount Series™, GX8 Rackmount Series™, NVIDIA DGX-1™ Microsoft' Stratix V FPGA™, Graphcore's Intelligent Processor Unit (IPU)™, Qualcomm's Zeroth Platform™ with Snapdragon processors™, NVIDIA's Volta™, NVIDIA's DRIVE PX™ NVIDIA's JETSON TX1/TX2 MODULE™, Intel's Nirvana™, Movidius VPU™, Fujitsu DPI™, ARM's DynamicIQ™, IBM TrueNorth™, and others.

Memory subsystem 3022 used in the storage subsystem 3010 can include a number of memories including a main random-access memory (RAM) 3032 for storage of instructions and data during program execution and a read only memory (ROM) 3034 in which fixed instructions are stored. A file storage subsystem 3036 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 3036 in the storage subsystem 3010, or in other machines accessible by the processor. Bus subsystem 3055 provides a mechanism for letting the various components and subsystems of computer system 3000 communicate with each other as intended. Although bus subsystem 3055 is shown schematically as a single bus, alternative implementations of the bus subsystem can use multiple busses.

Computer system 3000 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 3000 depicted in FIG. 30 is intended only as a specific example for purposes of illustrating the preferred embodiments of the present invention. Many other configurations of computer system 3000 are possible having more or less components than the computer system depicted in FIG. 30.

### Particular Implementations

We describe a system and various implementations of using machine learning and analytics to help brick and mortar stores compete with online shopping moguls. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

This method and other implementations of the technology disclosed can each optionally include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations.

### Location Tracking Infrastructure

The technology disclosed relates to symbiotic reporting code and location tracking infrastructure for physical venues.

The technology disclosed can be practiced as a system or systems, a method or methods, non-transitory computer readable storage medium storing instructions executable by a processor to perform any of the methods, of the or article of manufacture. One or more features of an implementation can be combined with the base implementation. The system or systems may include memory and one or more processors operable to execute instructions, stored in the memory, to perform any of the methods.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

In one implementation, we disclose an infrastructure system for generating visitor messages at a physical venue with at least five participating tenants. The technology disclosed not only applies to a single tenant location. This same approach may be applied to over multiple locations and sub-locations that have the same vendor operator. The infrastructure system includes a server registry of permission-based aggregated profiles with master identifiers (abbreviated IDs) for individual visitors. The server registry of the system includes (i) tenant-specific binned data individualized for the visitors that represents time-based events in time window bins organized into event categories, (ii) aggregated data individualized for the visitors that also represents time-based events in time-window bins organized into event categories, aggregated across at least the tenants, and (iii) pre-calculated intent propensities organized by the event categories, generated from the tenant-specific and aggregated data.

The system of this implementation also includes a location-based infrastructure of beacons. These beacons are deployable to the physical venue. The beacons generate distinctive messages. The system also includes a server beacon resolver that is able to determine visitor location based on receipt of beacon messages by mobile devices carried by the visitors. The system also includes symbiotic reporting code that is distributed to providers of apps that run on the mobile devices carried by the visitors that causes the mobile devices to collect the beacon messages. This symbiotic report code and the apps cause the mobile devices to report the beacon messages and a mobile device identifier to the server beacon resolver.

The system includes a location-based infrastructure of registered visitor Wi-Fi access points deployable to both the physical venue and a server Wi-Fi resolver. The server Wi-Fi resolver determines visitor location based on receipt of MAC address and registration identifiers from the mobile devices carried by the visitors. The system further includes a distribution server that distributes profile and location data to the participating tenants, when the distribution server is coupled in communication with (i) the server registry of the permission-based aggregated profiles, (ii) the server beacon resolver, and (iii) the server Wi-Fi resolver.

Examples of aggregated data individualized for the visitors include time-based events in time-window bins organized into event categories, collected from non-tenant entities.

Examples of time-based invents include interactions of an individual visitor with items in physical space, virtual space or online, with particular item interactions organized into particular event categories.

An example of an event includes an event that involves locations in the physical venue at times that an individual visitor was on a journey through the physical venue.

Other examples of aggregated data individualized for the visitors include individual visitor opt-in permissions for both location tracking and messaging organized by data source.

In an implementation the beacons transmit unique messages tied to their locations using Bluetooth Low Energy (abbreviated BLE). Additionally, in an implementation the distinctive messages from the beacons are encrypted.

The server beacon resolver of the system, in an example, receives (i) reports from mobile devices of at least one received beacon message and (ii) an accompanying received signal strength indicator (abbreviated RSSI). The serer beacon resolver, in an example, uses one beacon message to approximate a location. The server beacon resolver, in another example, uses multiple beacon messages to refine the location, and then reports the approximate or refined location.

The symbiotic reporting code, as an example, collects and reports (e.g., information) when the code in a foreground mode or when the code is active in a background mode of running on the mobile device.

In an example, registration (for use of the registered visitor Wi-Fi access points) associates a visitor email address with MAC address identifiers from the mobile devices carried by a registered visitor.

The registered visitor Wi-Fi access points, in an example, report obfuscated MAC addresses and access point identifiers to the server Wi-Fi resolver. As another example, the registered visitor Wi-Fi access points are configurable to report connected MAC addresses and access point identifiers to the server Wi-Fi resolver. Further, as an example, the registered visitor Wi-Fi access points report signal direction of arrival data with the MAC address identifiers. Additionally, for example, the registered visitor Wi-Fi access points report received signal strength indicator data (abbreviated RSSI) with the MAC address identifiers.

As a further example, the distribution server enforces proprietary boundaries between tenants. This prevents second tenant-specific data from being reverse engineered by a first tenant from distributed aggregated data and first tenant-specific data.

The permission-based aggregated profiles with master identifiers, for example, include a visitor name and other personally identifiable information. As another example, the permission-based aggregated profiles with master identifiers include a visitor photograph and other personally identifiable information. Additionally, for example, the permission-based aggregated profiles with master identifiers do not include a visitor name or visitor photograph.

In one implementation, we disclose a method of estimating a device location indoors from repeated readings of RSSI of multiple fixed location beacons. The method includes relating RSSI values to distances of a device from a transmitter beacon using a path loss exponent. This relationship is given in the following formula, with n representing the path loss exponent, d representing the device distance, and A representing a transmitter power:

RSSI (in dBm)=−10n log(d)+A

The PLE, in some implementations, is selected following a linear regression to estimate a best fit. The PLE can be selected to overestimate the distance to a beacon, instead of underestimating it, for reasons described above. Alternative PLEs can be used. One or more PLEs are supplied to the mobile device, as the PLE is better calculated as part of a system than by an individual mobile device. The mobile device may adaptively select among calculated PLEs or may switch between using the PLE approach indoors and using a devices' own estimated location when a reliable GNSS or GPS fix is available. Alternatively, a mobile device can selectively use the devices' own estimated location when the estimate is given with an estimated accuracy better than a predetermined threshold.

Using this relationship, distances from the fixed location beacons are interpolated, based on their measured RSSI values. Three or more beacons are selected to perform a multilateration of the mobile device. A start point for an estimated device location is first chosen. Then, the estimated device location is iteratively improved by stepping towards the location of one of the three beacons by a fraction of an uncertainty distance, relative to the measured RSSI from the transmitter beacon. Iteration stops when a predetermined convergence condition is met. Any of the conditions described above can be applied.

The estimated location can be improved iteratively using gradient descent.

The start point may be as discussed above. It can be a local origin (0,0), such as a corner or other point on a map of beacon locations. It can be a centroid location of beacon transmitters observed by the device. This centroid can of all observed beacons during a cycle or of a selected set of observed beacons. Criteria for selecting a set of beacons are discussed above. The start point can be a recent estimated device location. For instance, it can be the immediately preceding estimated location or a location within the last minute that meets a reliability criteria.

The relationship may be determined using a minimum, maximum or average RSSI during a predetermined scan period, when multiple RSSI values are measured during a scan period.

An uncertainty distance is calculated by determining a difference between the distance of a current estimated device location from a beacon and the calculated approximate distance of the device from the beacon. In some implementations, the approximate distance from the beacon is calculated using the formula:

RSSI (in dBm)=−10n log(d)+A

Further, an uncertainty distance RMS measure is an RMS average of uncertainty distances for beacons analyzed during an iteration.

A convergence condition is satisfied when a difference between uncertainty distance RMS measures in successive iterations is less than a meter.

Another convergence condition is satisfied when the RMS average distance to beacon circumferences calculated by the convergence algorithm falls below a threshold.

Another convergence condition is satisfied when, following an iteration, the uncertainty distance RMS measure is less than a threshold.

The path loss exponent n is a measure of signal attenuation.

In one implementation, the fraction of the uncertainty distance stepped is one-half

Another convergence condition is satisfied when the distance moved over the course of an iteration cycle is less than a predetermined threshold.

The methods disclosed above can realized in a mobile device. Such a device includes one or more radios coupled to at least one processor, and non-transient memory also coupled to the processor configured with instructions to carry out the methods and optional features of the methods.

The disclosed method may further include a way to set a reporting threshold for venue operators. Setting a reporting threshold included in a device that realizes the method can first includes calculating uncertainty distance measures between the estimated device location and individual beacons. Then, based on the uncertainty distance measures, the individual beacons are compiled into uncertainty distance range buckets. The threshold included in the device can be selected to include an upper limit of an uncertainty distance bucket and a percentage of beacons with uncertainty distances smaller than the upper limit.

Setting the path loss exponent n used in the mobile device can include evaluating alternative path loss exponents in order to validate that the path loss exponent is appropriate for the indoor location. The PLE can be selected to more often overestimate the distance to a beacon than underestimate the distance, for reasons explained above.

Evaluating the path loss exponent against alternative path loss exponents for use in the mobile device can include, for an alternative path loss exponent: calculating distances to beacons from RSSI values for the alternative path loss exponent nₐ using a formula

RSSI (in dBm)=−10nₐ log(d)+A,

collecting distances from location SDK measurements from mobile devices, calculating an average RMS difference between the location SDK measured distances and the calculated distances using the formula. When the average RMS differences is calculated for the alternative path loss exponents, the method selects the alternative path loss exponent with a smallest average RMS difference and compares the estimated path loss exponent with the selected alternative.

In some implementations, the distribution server is configurable to enforce proprietary boundaries between and within a tenant's physical location in order to associate an individual's physical location to a location between tenants and hyperlocation within the tenant.

In some implementations, a translation of the tenant's physical location within a proprietary boundary is further enriched to a hierarchy that substantially matches a retailer and/or a venue's business ontology.

### Machine Learning Intent Propensities

The technology disclosed relates to machine learning-based systems and methods of determining user intent propensity from binned time series data.

The technology disclosed can be practiced as a system or systems, a method or methods, non-transitory computer readable storage medium storing instructions executable by a processor to perform any of the methods, of the or article of manufacture. One or more features of an implementation can be combined with the base implementation. The system or systems may include memory and one or more processors operable to execute instructions, stored in the memory, to perform any of the methods.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

In one implementation, we disclose a method of configuring an intent propensity predictor. The method includes transforming time series of event data using a processor to form a training set. This transforming of the time series of event data further includes (i) binning hyper-location information by user from physical browsing by the user at a venue having multiple sub locations in time-oriented product category bins, (ii) further binning online browsing and consequent conversion history information of a user in time-oriented category bins (the category bins are hierarchically arranged from at least dozens of main categories through hundreds or thousands of conversion-specific items, such as product stock keeping units (abbreviated SKUs) and (iii) further binning PoS terminal information by user in the time-oriented category bins.

In an implementation the method further includes training a classifier using (i) a combination of the binned online browsing and consequent conversion history, (ii) the PoS terminal information, and (iii) the hyper-location information (collectively referred to as binned data), to output category intent propensities on a per user basis. The method, in an implementation, includes persisting coefficients resulting from the training of the classifier.

A further implementation of the method includes combining binned purchase amount information with the category intent propensities. The method, for example, also includes training the classifier using the combination to output an expected product category purchase value on the per user basis.

In an implementation, the output of, for example, the category intent propensities, is generated in dependence upon account seasonal factors.

An example implementation of the method also includes training the classifier for a specific sub location of the venue using sub location-specific binned data individualized for the users.

In one implementation the method further aggregates the binned data individualized for the users across non-tenant binned browsing and consequent conversion history information of a user in time-oriented category bins. The technology disclosed not only applies to a single tenant at a single location. This same approach may be applied to over multiple locations and sub-locations that have the same vendor operator.

Examples of some of the events include interaction of the user with items in physical space, virtual space or online, with particular item interactions organized into particular event categories. Other examples of the events include locations in the physical venue at times that the user was on a journey through the venue.

In an implementation the method utilizes individual user opt-in permissions for location tracking and for messaging organized by data source.

### Visitor to Venue

The technology disclosed relates to using machine learned visitor intent propensity to greet and guide a visitor at a physical venue.

The technology disclosed can be practiced as a system or systems, a method or methods, non-transitory computer readable storage medium storing instructions executable by a processor to perform any of the methods, of the or article of manufacture. One or more features of an implementation can be combined with the base implementation. The system or systems may include memory and one or more processors operable to execute instructions, stored in the memory, to perform any of the methods.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

In one implementation related to greeting upon arrival, we disclose a method of greeting a visitor at a venue. The method, for example, includes recognizing arrival of a mobile device carried by a visitor at a venue having participating tenants. The technology disclosed not only applies to a single tenant at a single location. This same approach may be applied to over multiple locations and sub-locations that have the same vendor operator.

The method also includes informing servers representing the participating tenants of arrival of the visitor. This “informing” is accompanied by a profile of the visitor, tenant-specific information and aggregate intent propensity information. The method further includes receiving and evaluating proposed messages from the servers representing the participating tenants for a predetermined limit on messages. According to the method, selected methods are forwarded, where the messages are selected by the evaluating to the mobile device carried by the visitor.

In an example implementation, the method includes recognizing the arrival of the mobile device carried by the visitor. This is based on beacon reporting from the mobile device carried by the visitor.

As an example of the beacon reporting, the beacon reporting is received from symbiotic reporting code running on an app on the mobile device. The app on the mobile device can be (i) a social media app, (ii) a navigation app, and/or (iii) a ride sharing app. The app can also be running in a foreground mode or an active background mode of the mobile device. As another example of the beacon reporting, the beacon reporting includes at least one encrypted message from a beacon having a registered location within the venue.

Further, as an example of the profile, the profile includes (i) a visitor name, (ii) a visitor photograph, (iii) other personally identifiable information and/or (iv) a unique identifier but not a visitor name or photograph.

In an implementation, the intent propensity information does not include a specific predetermined intent based on recent online activity of the visitor. Additionally, for example, the tenant-specific and aggregate intent propensity information is pre-calculated prior to the arrival and binned by category in the visitor's profile.

According to an implementation, the method includes evaluating the proposed messages for at least consistency with (between) the tenant-specific and aggregate intent propensity information.

Examples of evaluating the proposed messages, as performed by the method, are provided below. One example includes evaluating the proposed messages for consistency based on semantic analysis of the proposed messages against the tenant-specific and aggregate intent propensity information. Other example includes evaluating the proposed messages, for example, using a multi-layer convolutional neural network. Another example includes updating the evaluating of the proposed messages (as a location of the visitor within the venue) using a recurrent neural network. Another example includes updating the evaluating of the proposed messages (as a location of the visitor within the venue) using a convolutional neural network, a multi-layer convolutional neural network, and an attention mechanism.

In an implementation the method includes queuing unused messages among the received messages. As an example, the selected unused messages are forwarded to the visitor based on location updates obtained or that occurred during a journey of the visitor through the venue. For example, according to the method, the messages selected by the evaluating are forwarded to the mobile device within less than five minutes of the arrival.

Further, in an implementation, the method includes determining that the visitor has at least one identified intent upon arrival at the venue. This is done using recent online browsing activity. Additionally, the method includes, for example, informing the participating tenants of the identified intent and/or evaluating the proposed messages from the servers representing the participating tenants for at least consistency with the identified intent.

The method, in an implementation, includes prioritizing the proposed messages based at least in part to complement the identified intent. Additionally, the method includes delivering the prioritized messages not exceeding the message limit.

Further example of the method include (i) determining that the visitor has at least one identified intent upon arrival at the venue, where this can be done based on an entitlement being fulfilled at the venue, (ii) further informing the participating tenants of the identified intent, and (iii) further evaluating the proposed messages from the servers representing the participating tenants for at least consistency with the identified intent.

In one implementation related to a next best offer or obtaining a next best offer, we disclose a method of helping a visitor proceed in a journey through a facility having multiple tenants. The technology disclosed not only applies to a single tenant at a single location. This same approach may be applied to over multiple locations and sub-locations that have the same vendor operator. The method includes planning, upon arrival at the facility, a sequence of messages to lead the visitor on the journey through the facility. This sequence of messages is constructed based on (i) binned profile data for the visitor and, at least, (ii) a calculation of current intent indications for the visitor.

The method of this implementation further includes updating the plan based on hyper-location data obtained after the arrival. This reveals a course of an actual journey by the visitor through the facility. The method further includes periodically messaging a mobile device carried by the visitor with messages based on the updated plan.

In an implementation according to this method, a dwell time of the visitor at two or more tenants that is used in a recalculation, results in changed current intent indications. Further, the method includes causing presentation of an incentive to the visitor based on the recalculation.

In another implementation the method informs servers representing the tenants of arrival of the visitor. This informing is accompanied by the changed current intent indications. Also, in an example the method receives and evaluates proposed messages from the servers representing the tenants, and forwards messages selected by the evaluating to the mobile device carried by the visitor.

For example, the dwell time of the visitor at two or more tenants are used in a recalculation and results in changed current intent indications, such that the method informs servers representing the tenants of arrival of the visitor, accompanied by the changed current intent indications.

In an implementation the method receives and evaluates proposed messages from the servers representing the tenants and also forwards messages selected by the evaluating to the mobile device carried by the visitor.

### Gender and Age Context

The technology disclosed relates to providing gender and age context for user intent when browsing or searching.

The technology disclosed can be practiced as a system or systems, a method or methods, non-transitory computer readable storage medium storing instructions executable by a processor to perform any of the methods, of the or article of manufacture. One or more features of an implementation can be combined with the base implementation. The system or systems may include memory and one or more processors operable to execute instructions, stored in the memory, to perform any of the methods.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

In one implementation, we disclose a method of enhancing a user browsing experience. This method includes receiving a gender context query from a provider for a content request by an identified user, and also includes accessing an aggregated profile with an interest history organized by provider for the identified user. In an implementation includes determining an a priori most likely gender context based on the provider and the aggregated profile, as well as returning a gender context identifier responsive to the query, based on the determining.

An example of the aggregated profile for the identified user includes pre-calculated clusters of gender and age for distinct personalized historical interests of the identified user. The method, for example, determines the a priori most likely gender context as one of the distinct personalized historical interests.

Examples of the pre-calculated clusters include style preferences of the distinct personalized historical interests.

Another example of the aggregated profile for the identified user includes pre-calculated historical frequencies of gender and age interest, organized by provider for the identified user.

In an implementation the method accesses recent browsing history of the identified user, as well as combines a priori likelihood with recent browsing history to determine the most likely gender context.

Further, for example the method includes receiving an age context query with the gender context query. This makes it possible to use the aggregated profile for the identified user to determine and return the most likely age context.

An implementation of this method, for example includes (i) receiving an age context query with the gender context query, and/or (ii) using the aggregated profile for the identified user to determine and return the most likely age context as one of the distinct personalized historical interests.

According to another implementation the method (i) receives an age context query with the gender context query, and/or (ii) uses the aggregated profile for the identified user to determine and return the most likely age context.

In a further implementation the method (i) receives an age context query with the gender context query, and/or (ii) combines a priori likelihood with recent browsing history to determine and return the most likely age context.

### Ensemble

The technology disclosed relates to generating an individualized ensemble of complementary items in complementary item categories.

The technology disclosed can be practiced as a system or systems, a method or methods, non-transitory computer readable storage medium storing instructions executable by a processor to perform any of the methods, of the or article of manufacture. One or more features of an implementation can be combined with the base implementation. The system or systems may include memory and one or more processors operable to execute instructions, stored in the memory, to perform any of the methods.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

In one implementation, we disclose a method of enhancing a user browsing experience. The method includes detecting an indication of interest in an item for an identified user, as well as invoking an ensemble engine with the item of interest. The method, for example, also responsively receives, from the ensemble engine, an ensemble of item categories that complement the item of interest.

Further, the method retrieves an aggregate profile for the identified user, as well as determines preference of the user for a category among recommended categories in the ensemble of item categories, determines feature preferences of the identified user that apply to the recommended categories, and uses the determined category and feature preferences to select items to include in an ensemble of items. The method also includes causing display (to the identified user) of the ensemble of items selected using the determined category and feature preferences of the identified user.

In another implementation the method detects the interest in the item (i) during online browsing by the identified user, (ii) during physical browsing by the identified user at a physical location, and/or (iii) from a PoS terminal adjacent to the identified user.

In an example, the method determines (from the aggregate profile) a group interest pattern. The method can also select items from the group interest pattern to include in the ensemble of items selected.

In various implementations the method determines (i) a style preference among the feature preferences, (ii) a size preference among the feature preferences, and/or (iii) a color preference among the feature preferences.

In other various implementations the method causes display (to the user) on (i) a mobile device held by the user, (ii) a display adjacent to the user, and/or (iii) a display of a mobile device held by a person assisting the user.

### Modifying Purchase Behavior

The technology disclosed relates to systems and methods of individualized incentives to modify shopper behavior.

The technology disclosed can be practiced as a system or systems, a method or methods, non-transitory computer readable storage medium storing instructions executable by a processor to perform any of the methods, of the or article of manufacture. One or more features of an implementation can be combined with the base implementation. The system or systems may include memory and one or more processors operable to execute instructions, stored in the memory, to perform any of the methods.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

In one implementation related to buying online and returning at a store, we disclose method of handling returns for retailers with both online and physical presences. The method includes interacting with a user online responsive to a return request, as well as evaluating specific goods identified by the user to be returned and determining a first incentive value based on a cost of processing the return. The method also causes presentation (to the user) of an incentive offer that is less than or equal to the first value in exchange for returning the specific goods at a physical location instead of by shipping. The method further, upon accepting the incentive, pre-arranges receipt of return of the specific goods at the physical location. This can also include giving the user a token to present when visiting the physical location.

Examples of evaluating the specific goods include (i) taking into account the user's history of return to a physical location of goods purchased online and/or (ii) taking into account and a history of return patterns by the user.

In an implementation the method (i) evaluates binned profile data for the user, (ii) determines a second incentive value based on bringing the user to a physical location, and/or (iii) combines the first and second incentive values and presenting the user the incentive offer with a value less than or equal to the combined first and second incentive values, instead of an offer with a value less than or equal to the first incentive value.

In an example implementation the method directs the incentive to ensemble items available at the physical location. In another example implementation the method causes presentation of a list of physical locations to the user and receives a selection of the physical location for return. In a further example implementation the token to present is a scan code pattern.

In another implementation related to buying online and picking up at a store, we disclose method of handling fulfillment for retailers with both online and physical presences. This method interacts with a user online responsive to a purchase request, evaluates specific goods identified by the user to be purchased, and determines a first incentive value based on a cost of fulfilling the purchase request. Further, this method includes causing presentation (to the user) of an incentive offer that is less than or equal to the first value in exchange for picking up the specific goods at the physical location instead of receiving the specific goods by shipping. Additionally, this method, upon acceptance of the incentive, pre-arranges pick up of the specific goods at the physical location, including giving the user a token to present when visiting the physical location.

In an example implementation of this method, the method determines immediate availability of the specific goods ordered and accompanying the incentive offer with assertion of the immediate availability.

An example of evaluating specific goods, as performed by this method, includes evaluating specific goods identified by taking into account the user's history of pick up from a physical location of online purchases.

In an implementation the method includes (i) evaluating binned profile data for the user and determining a second incentive value based on bringing the user to a physical location, (ii) combining the first and second incentive values, and/or (iii) presenting the user the incentive offer with a value less than or equal to the combined first and second incentive values, instead of an offer with a value less than or equal to the first incentive value.

The method also includes, in an example implementation, (i) directing the incentive to ensemble items available at the physical location, and/or (ii) causing presentation of a list of physical locations (to the user) and receiving a selection of the physical location for return. In another implementation the token to present is a scan code pattern.

In one implementation related to underestimated shoppers, we disclose method of converting shoppers to in-retailer purchases. This method includes receiving an identified shopper from a retailer with an interest context directed to a product, as well as determining a product category that includes the product. In an implementation this method also determines (from an aggregated profile for the identified shopper) (i) an in-retailer purchase propensity and (ii) overall purchase propensity for the product category or for an ensemble of related product categories. The method further includes comparing the in-retailer purchase propensity and overall purchase propensity, as well as determining that the in-retailer purchase propensity underestimates the overall purchase propensity. This method also causes an alert (based on the determined underestimate) to the retailer that the identified purchaser is a conversion candidate for in-retailer purchases.

Examples of identified shoppers being received include the identified shopper being received from the retailer from (i) the retailer during online browsing by the shopper, (ii) the retailer during physical browsing by the shopper, and/or (iii) the retailer from a point-of-sale system during checkout by the shopper.

In an implementation the method determines the product category within a SKU hierarchy from a SKU.

In another implementation the method calculates and causes display of an incentive to convert the identified shopper to an in-retailer purchase in the product category or ensemble of product categories.

The method, for example also includes causing initiating of direct marketing (to the identified shopper) directed to the product category or ensemble of product categories.

In one implementation related to price elasticity, we disclose method of customizing an incentive for a visitor. This method includes receiving a specification of one or more goods under consideration by a visitor who has a purchase history, as well as determining a set of prior purchases of prior goods by the visitor in one or more categories correlated with the goods under consideration. This method further compares prices actually paid for the prior goods with standard prices for the prior goods, and also generates a discount-orientation rating for the visitor based on the comparing.

In an example implementation this method receives the specification of the goods under consideration, as product stock keeping units (abbreviated SKUs), as well as determines the categories correlated with the goods under consideration. This is done from a hierarchy arranged from dozens of main categories through hundreds or thousands of SKUs.

In another example implementation the method (i) generates a numerical discount-orientation rating, (ii) generates a categorical discount-orientation rating, (iii) adjusts an incentive presented to the visitor based on the discount-orientation rating, (iv) determines to provide a future upgrade incentive to the visitor based on a price insensitive discount-orientation rating, and/or (v) determines to provide an discount incentive to the visitor based on a price sensitive discount-orientation rating.

In one implementation related to a luxury buyer special service, we disclose method of rationing attention devoted to a visitor. This method includes receiving a signal from a mobile device allowing identification of a visitor upon arrival at a venue, as well as accessing an aggregated profile for the identified visitor, and determining an aggregated luxury purchase index for a particular retailer at the venue and a luxury purchase index aggregated across retailers. This message also includes messaging a server representing the particular retailer at the venue identifying the visitor as a luxury buyer based on one or both of the luxury purchase indexes.

In an example implementation this method involves multiple participating retailers being located at a venue further including. This further includes informing servers representing the participating retailers of arrival of the visitor at the venue, accompanied by a profile of the visitor and retailer-specific and aggregate intent propensity information from the aggregated profile. Additionally, this method includes receiving and evaluating proposed messages from the servers representing the participating retailers, as well as forwarding messages selected by the evaluating to the mobile device carried by the visitor.

Examples of this method further includes evaluating the proposed messages for (i) at least likelihood of success based on the aggregate intent propensity information, and/or (ii) at least price offered for delivery of the proposed messages.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

While the present technology is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the technology and the scope of the following claims.

What is claimed is:

1. An infrastructure system for generating visitor messages at a physical venue with multiple participating tenants, the infrastructure system including:
a server registry of permission-based aggregated profiles with master identifiers (abbreviated IDs) for individual visitors, including,
tenant-specific binned data individualized for the visitors that represents time-based events in time window bins organized into event categories,
aggregated data individualized for the visitors that also represents time-based events in time-window bins organized into event categories, aggregated across at least the tenants, and
pre-calculated intent propensities organized by the event categories, generated from the tenant-specific and aggregated data; and
a location-based infrastructure of beacons deployable to the physical venue that generate distinctive messages and a server beacon resolver configurable to determine visitor location based on receipt of beacon messages by mobile devices carried by the visitors;
symbiotic reporting code distributed to providers of apps that run on the mobile devices carried by the visitors that causes the mobile devices to collect the beacon messages and cause the mobile devices to report the beacon messages and a mobile device identifier to the server beacon resolver;
a location-based infrastructure of registered visitor Wi-Fi access points deployable to the physical venue and a server Wi-Fi resolver configurable to determine visitor location based on receipt of MAC address and registration identifiers from the mobile devices carried by the visitors; and
a distribution server configurable to distribute profile and location data to the participating tenants, when coupled in communication with the server registry of permission-based aggregated profiles, the server beacon resolver, and the server Wi-Fi resolver.

2. The infrastructure system of claim 1, wherein the aggregated data individualized for the visitors further represents time-based events in time-window bins organized into event categories, collected from non-tenant entities.

3. The infrastructure system of claim 1, wherein at least some of the time-based events involve interaction of an individual visitor with items in physical space, virtual space or online, with particular item interactions organized into particular event categories.

4. The infrastructure system of claim 1, wherein at least some of the events involve locations in the physical venue at times that an individual visitor was on a journey through the physical venue.

5. The infrastructure system of claim 1, wherein the aggregated data individualized for the visitors further includes individual visitor opt-in permissions for location tracking and for messaging organized by data source.

6. The infrastructure system of claim 1, wherein the beacons are configurable to transmit unique messages tied to their locations using Bluetooth Low Energy (abbreviated BLE).

7. The infrastructure system of claim 1, wherein the server beacon resolver is configurable to receive reports from mobile devices of at least one received beacon message and an accompanying received signal strength indicator (abbreviated RSSI), to use one beacon message to approximate a location, and to use multiple beacon messages to refine the location, then to report the approximate or refined location.

8. The infrastructure system of claim 7, wherein the distribution server is configurable to enforce proprietary boundaries between and within a tenant's physical location in order to associate an individual's physical location to a location between tenants and hyperlocation within the tenant.

9. The infrastructure system of claim 8, wherein a translation of the tenant's physical location within a proprietary boundary is further enriched to a hierarchy that substantially matches a retailer and/or a venue's business ontology.

10. A method of estimating a device location indoors from repeated readings of RSSI of multiple fixed location beacons, including:
relating RSSI values to distance of a device from a transmitter beacon using a path loss exponent (PLE) n in a formula:
RSSI (in dBm)=−10n log(d)+A
calculating approximate distances of the device from three or more transmitter beacons at known fixed locations using the PLE; and
then, iteratively improving an estimated device location by stepping towards the location of one of the three or more transmitter beacons by a fraction of an uncertainty distance, relative to the RSSI from the transmitter beacon until a predetermined convergence condition is met.

11. The method of claim 10, further including using gradient descent to iteratively improve the estimated device location, including starting the iterative improvement from a start point,
wherein the start point is one of local coordinate (0,0), a centroid of beacon transmitters observed or locations provided by the device, and a recent estimated device location,
wherein the uncertainty distance is calculated by determining a difference between the distance of a current estimated device location from a beacon and the calculated approximate distance of the device from the beacon, and
wherein an uncertainty distance RMS measure is an RMS average of uncertainty distances for beacons analyzed during an iteration.

12. The method of claim 11, wherein a convergence condition is satisfied when a difference between uncertainty distance RMS measures in successive iterations is less than a tenth of a meter,
wherein the convergence condition is satisfied when the RMS average distance to beacon circumferences calculated falls below a threshold, and
wherein the convergence condition is satisfied when, following an iteration, the uncertainty distance RMS measure is less than a threshold.

13. A mobile device including at one or more radios coupled to at least one processor with instructions configured to practice the method of claim 10, wherein a threshold for reporting a visitor's location has been selected by:
calculating uncertainty distance measures between the estimated device location and individual beacons;
based on the uncertainty distance measures, compiling the individual beacons into uncertainty distance range buckets; and
selecting the threshold for reporting a visitor's location, the threshold including an upper limit of an uncertainty distance bucket and a percentage of beacons with uncertainty distances smaller than the upper limit.

14. A mobile device including at one or more radios coupled to at least one processor with instructions configured to practice the method of claim 10, wherein the path loss exponent n has been evaluated against alternative path loss exponents, in order to validate that the path loss exponent is appropriate for a location in which the mobile device is used.

15. A mobile device including at one or more radios coupled to at least one processor with instructions configured to practice the method of claim 14, wherein selecting the path loss exponent against alternative path loss exponents has included:
for an alternative path loss exponent:
calculating distances to beacons from RSSI values for the alternative path loss exponent nₐ using a formula
RSSI (in dBm)=−10nₐ log(d)+A
collecting distances from location SDK measurements from mobile devices.
calculating an average RMS difference between the location SDK measured distances and the calculated distances using the formula;
selecting the alternative path loss exponent with a smallest average RMS difference; and
numerically comparing the estimated path loss exponent with the selected alternative.

16. The method of claim 15, wherein the path loss exponent n is a measure of signal attenuation.

17. The method of claim 15, wherein a convergence condition is satisfied when the distance moved during an iteration cycle is less than a predetermined threshold.
